(19) United States
(12) Patent Application Publication
(10) Pub. No.: US 2021/0331947 A1
(43) Pub. Date: Oct. 28, 2021

(54) METHOD FOR SELECTIVE SEPARATION OF IONIC SPECIES FROM IONIC SOLUTION BASED ON IONIC HYDRATED SIZE

(71) Applicant: TECHION RESEARCH AND DEVELOPMENT FOUNDATION LIMITED, Haifa (IL)

(72) Inventors: Matthew SUSS, Haifa (IL); Eric GUYES, Haifa (IL); Yinke CHEN, Haifa (IL); Rana UWAYID, Haifa (IL)

(21) Appl. No.: 17/273,469

(22) PCT Filed: Sep. 4, 2019
(86) PCT No.: PCT/IL2019/050986

§ 371 Date: Mar. 4, 2021

Related U.S. Application Data
(60) Provisional application No. 62/726,994, filed on Sep. 5, 2018.

(51) Int. Cl. C02F 1/469; H01G 11/32; H01G 11/26

(52) U.S. Cl. CPC C02F 1/4691; C02F 2201/46; H01G 11/26; H01G 11/32

(57) ABSTRACT

The present invention relates to methods for selective separation of ionic species from an ionic solution based on said species' ionic hydrated size, the method comprising, inter alia, passing an ionic solution comprising ions having distinct hydrated sizes, through an electrode capacitor assembly comprising at least one carbon-based electrode which is modified with negatively or positively charged surface groups. Further provided is a method for selective separation of ionic species from an ionic solution comprising passing the ionic solution comprising a first positively charged ion and a second positively charged in through an electrode capacitor assembly, wherein the first modified electrode comprises carbon modified with sulfonate surface groups.

### FIELD OF THE INVENTION

The present invention relates to a method for selective separation of ionic species from an ionic solution based on said species' ionic hydrated size, the method utilizing an electrode capacitor assembly comprising carbon electrodes modified with charged surface groups.

### BACKGROUND OF THE INVENTION

Capacitive deionization (CDI) is an emerging technology which can be used in various applications, such as but not limited to, brackish water desalination, water softening, wastewater remediation, agricultural applications, and organic stream remediation.

For water desalination by CDI, a feedwater stream is treated using the phenomenon of electrosorption in porous carbon electrodes, which is a capacitive process (Porada, S. et al. Review on the Science and Technology of Water Desalination by Capacitive Deionization. Prog. Mater. Sci. 2013, 58 (8), 1388-1442). CDI cells usually employ at least two porous carbon electrodes, and a separator layer between the electrodes which can serve as the feedwater stream flow channel. During operation, the electrodes become electrically charged by applying a voltage thereto, causing ions from the feedwater stream to become electrosorbed into electric double layers (EDLs), which occupy the pore volume on the surface of the electrodes. The CDI operation thus results in the desalination of the feedwater stream.

Compared to more established desalination technologies, such as reverse osmosis (RO) and flash distillation (FD), CDI technology does not require high pressure pumps or heat sources. Therefore, CDI systems can be highly scalable and energy efficient.

The operation of CDI cells can be improved and optimized, by increasing the carbon electrodes' microporosity (Porada et al., ibid). In addition to the pore size distribution (PSD), Gao et al. examined carbon electrodes with enhanced chemical surface charge, which showed enhanced salt adsorption capacity (SAC) in the volume of the pores of the electrodes (Gao X., et al., Complementary surface charge for enhanced capacitive deionization. Water research, 2016, 92: 275-282). Enhanced salt adsorption capacity can be afforded by attaching charged ionic groups to the surface of the electrodes. For example, Gao et al., modified carbon cloth electrodes by treating them in nitric acid and ethylenediamine solutions, resulting in chemical surface charge enhanced carbon electrodes for capacitive deionization (CDI) applications. In said publication, the cathode was enhanced with negative surface charges (carboxylic groups), and the anode was enhanced with positive surface charges (amine and/or amide).

Use of nitric acid was also reported by Avraham et al., in a study which assessed the charge efficiency of electrochemical capacitive deionization (CDI) processes without limiting the range of applied potentials, by using surface-treated (oxidized) activated carbon fiber (ACF) electrodes. It was shown that it is possible to positively shift the potential of zero charge (PZC) of the activated carbon electrodes by their controlled oxidation in HNO₃ solution, wherein the obtained positive shift in the PZC remained very stable in NaCl solutions (Avraham et al., Enhanced Charge Efficiency in Capacitive Deionization Achieved by Surface-Treated Electrodes and by Means of a Third Electrode. J. Phys. Chem. C 2011, 115, 19856-19863).

US Patent Application No. 2014/0346046 discloses a polarized electrode flow through capacitor, comprising an anion-permeable electrode containing cationic groups, and a cation-permeable electrode containing anionic groups. The contained groups cause the electrodes to be polarized so that they are selective to anions or cations eliminating the need for a separate charge barrier material.

Porous carbon CDI electrodes were also shown to exhibit selective ion removal based on ion size, with the smaller ion being preferentially removed in the case of equal-valence ions. Theoretical model depicting size-based selectivity in porous carbon CDI systems was provided in Suss, M. E. “Size-based ion selectivity of micropore electric double layers in capacitive deionization electrodes”, Journal of The Electrochemical Society, 164(9), E270-E275, 2017.

Certain ions, such as fluoride (F⁻), nitrate (NO₃⁻), ferric (Fe³⁺) and chromate (CrO₄²⁻), pose serious health risks even at low concentrations. Therefore, the selective removal of hazardous ions, while maintaining other ions, which presence in drinking water or agricultural applications is beneficial, can enable an energy efficient treatment for enhanced desalination of brackish water feed streams.

There remains, therefore, an unmet need for an effective electromechanical capacitor systems and method for CDI-based desalination, which enable energy efficient and chemically and mechanically stable selective ion separation.

### SUMMARY OF THE INVENTION

The present invention provides a method for selective separation of ionic species from an ionic solution based on said species ionic hydrated size. The method comprises, inter alia, passing an ionic solution comprising ions having distinct hydrated sizes, through an electrode capacitor assembly comprising at least one carbon-based electrode which is modified with charged surface groups.

The present invention is based in part on an unexpected finding that by modifying the surface of the electrodes with specific negatively and/or positively charged surface groups, selective separation of ionic species from an ionic solution, based on said species ionic hydrated size, can be effectively achieved. Without wishing to being bound by theory, it is contemplated that the electrode capacitor assembly of the present invention provides enhanced specific adsorption of ionic species having smaller ionic hydrated sizes. The enhanced specific adsorption is possible due to the presence of negatively and/or positively charged surface groups, present on the surface of the micropores' volume. When the electrodes are charged via application of a voltage or current, said charged surface groups increase the electrical potential of electrodes, therefore increasing the electrosorption capabilities of said modified electrodes towards ionic species having smaller hydrated radius, resulting in a selective desalination.

The inventors of the present invention have further surprisingly found that at high operating voltages the measured ion size-based selectivity of the negatively modified electrode was lower than predicted by the theoretical model. Without wishing to being bound by theory or mechanism of action, it is contemplated that the lower selectivity stems from the reduced surface charge of said negatively charged electrode. In contrast to the beneficial effect of the carboxylic group functionalities obtained by nitric acid treatment of the carbon electrode reported by Gao, inventors of the present invention observed unexpected mechanical instability of carboxylic groups at high operating potentials (above about 0.4V), leading to lower negative chemical surface charge of the oxidized cathode, which assumingly resulted in impaired ion selectivity separation. Additionally, operation of the electrode capacitor assembly was challenged by high pH sensitivity of the surface carboxylic groups leasing to unstable and unreliable separation performance.

Based on these surprising findings, the inventors have developed carbon electrodes comprising more stable surface groups, including, inter alia, sulfonate and amine-based electrodes, which should provide enhanced selective separation even at high operating voltages, which are preferable in terms of separation process efficiency.

The ion size-based separation afforded by the method of the present invention is particularly useful in applications which require removal of monovalent ions and enriching solutions in polyvalent ions, while commonly-used separation techniques offer preferential removal of polyvalent ions.

Thus, according to a first aspect, the present invention provides a method for selective separation of ionic species from an ionic solution based on said species ionic hydrated size, the method comprising: (a) passing an ionic solution comprising at least a first ion and a second ion, said ions being of the same polarity and having distinct hydrated sizes, through an electrode capacitor assembly comprising a first electrode and a second electrode, said electrodes comprising carbon having a pore structure comprising micropores, wherein the first electrode is a modified electrode comprising carbon which is modified with negatively charged surface groups and/or the second electrode is a modified electrode comprising carbon which is modified with positively charged surface groups, and at least one flow channel for the passage of the solution; and (b) applying an electric potential or charge to the first and the second electrodes, thereby providing enhanced adsorption of the first ion in the first modified electrode or in the second modified electrode, as compared to the adsorption of the second ion.

According to some embodiments, the hydrated size of the first ion is smaller compared to the hydrated size of the second ion, by at least about 5%. In some embodiments, the first ion is a monovalent ion and the second ion is a polyvalent ion.

According to some embodiments, the micropores have a mean pore diameter of below about 2 nm. In some embodiments, the initial surface pH of the first electrode and/or the second electrode ranges from about 6 to about 8. According to some embodiments, the first modified electrode has a surface charge of at least about 3 M at a pH of 8 or above. According to some embodiments, the electrode capacitor assembly is characterized by having a separation factor of above about 1.3, for the first ion and the second ion.

According to some embodiments, the first electrode, the second electrode or both comprise carbon, which is selected from the group consisting of activated carbon, carbon black, graphitic carbon, carbon fibers, carbon microfibers, carbon aerogel, fullerenic carbons, carbon nanotubes (CNTs), graphene, carbide, carbon onions, carbon paper, and any combination thereof. Each possibility represents a separate embodiment of the invention. In certain embodiments, the first electrode, the second electrode, or both comprise activated carbon.

According to some embodiments, the negatively charged surface groups of the first modified electrode are selected from the group consisting of carboxyl, lactone, quinone, sulfate, sulfonate, phosphate, nitro, halide, hydroxyl, ether, carbonyl, and combinations thereof. According to some embodiments, the first electrode is a modified electrode and the negatively charged surface groups of the first modified electrode comprise sulfonate. According to some embodiments, at least about 95% of the surface coverage by the negatively charged surface groups of the first electrode and/or by the positively charged surface groups of the second electrode is retained following a single cycle of operation of the electrode capacitor. According to some embodiments, the negatively charged surface groups are attached to the surface of the first electrode by covalent bonds.

According to some embodiments, the first electrode has a surface area of above about 500 m²/g.

According to some embodiments, the first electrode is a cathode, wherein said cathode comprises activated carbon, which is modified by oxidation. According to some embodiments, the second electrode is an anode, wherein said anode comprises activated carbon, which is not chemically modified.

According to some embodiments, the positively charged surface groups are selected from the group consisting of: amine, amide, quaternary amine, ammonium, or combinations thereof. Each possibility represents a separate embodiment of the invention.

According to some embodiments, the ionic solution comprises ionic species which are selected from the group consisting of: Li⁺, Na⁺, K⁺, Mg²⁺, Ca²⁺, Cl⁻, Br⁻, F⁻, NO₃⁻, Fe²⁺, Fe³⁺, CrO₄²⁻, Pb²⁺, Hg²⁺, Cd²⁺, In³⁺, Ru³⁺, Ru⁴⁺, Zn²⁺, Co²⁺, Co³⁺, Pt²⁺, Pt⁴⁺, Au⁺, Au³⁺, Ag⁺, Sn⁴⁺, Sn²⁺, Sn⁴⁻, Cu²⁺, and combinations thereof. Each possibility represents a separate embodiment of the invention.

According to some embodiments, the ionic solution further comprises water or an organic solvent. The organic solvent can be selected from the group consisting of propylene carbonate, propylene glycol, acetonitrile, tetrahydrofuran, diethyl carbonate, γ-butyrolactone, and combinations thereof. Each possibility represents a separate embodiment of the invention.

According to some embodiments, the at least one flow channel is formed by at least one of a separator, membrane, gasket, spacer, and salt bridge. According to some embodiments, the electrode capacitor assembly further comprises a first current collector and a second current collector. According to some embodiments, the first electrode is positioned between the first current collector and the flow channel, and the second electrode is positioned between the flow channel and the second current collector.

According to some embodiments, the first electrode, second electrode, or both, comprise a flowable carbon electrode in the form of a suspension and/or a fluidized bed electrode.

According to some embodiments, the ionic solution flows in the flow channel directly through the electrodes, wherein the flow within the flow channel is configured orthogonally to the electrode surface plane.

According to some embodiments, the electrode capacitor assembly is in electrical communication with a power supply, wherein during operation said power supply is configured to apply electrical potential or to supply electric charge to the first and the second electrodes.

According to some embodiments, the electrode capacitor assembly is a part of a wastewater treatment system or brackish water desalination system. According to some embodiments, the flow channel comprises at least two ion-permeable membranes. According to some embodiments, the water desalination system is configured in a form of a Capacitive Deionization (CDI) system or a Membrane Capacitive Deionization System (MCDI). According to some embodiments, the CDI and or MCDI system further comprises a feed tank, a feed pump, and a waste tank.

According to some embodiments, the electrode capacitor assembly is a part of a chemical reactor.

According to another aspect, there is provided a method for selective separation of ionic species from an ionic solution based on said species ionic hydrated size, the method comprising: (a) passing the ionic solution comprising at least a first positively charged ion and a second positively charged ion having distinct hydrated sizes, through an electrode capacitor assembly comprising a first electrode and a second electrode, said electrodes comprising carbon having a pore structure comprising micropores, wherein the first electrode comprising carbon is modified with sulfonate surface groups, and at least one flow channel for the passage of the solution; and (b) applying an electric potential or charge to the first and the second electrodes, thereby providing enhanced adsorption of the first positively charged ion in the first electrode as compared to the adsorption of the second positively charged ion.

According to some embodiments, the hydrated size of the first positively charged ion is smaller compared to the hydrated size of the second positively charged ion, by at least about 5%. According to further embodiments, the first positively charged ion is a monovalent ion and the second positively charged ion is a polyvalent ion.

According to some embodiments, the micropores have a mean pore diameter of below about 2 nm.

According to some embodiments, the first electrode, the second electrode or both comprise carbon selected from the group consisting of activated carbon, carbon black, graphitic carbon, carbon fibers, carbon microfibers, carbon aerogel, fullerenic carbon, carbon nanotubes (CNTs), graphene, carbide, carbon onions, carbon paper, and any combination thereof. Each possibility represents a separate embodiment of the invention. In certain embodiments, the first electrode, the second electrode, or both comprise activated carbon.

According to some embodiments, at least about 95% of the surface coverage by sulfonate surface groups of the first electrode is retained following a single cycle of operation of the electrode capacitor.

According to some embodiments, the first electrode has a surface area of above about 500 m²/g.

According to some embodiments, the first electrode is a cathode and the second electrode is an anode, wherein said anode comprises activated carbon, which is not chemically modified.

According to some embodiments, the first electrode is a cathode and the second electrode is an anode, wherein said anode comprises activated carbon, which is modified by positively charged surface groups. The positively charged surface groups can be selected from the group consisting of amine, amide, quaternary amine, ammonium, and combinations thereof. Each possibility represents a separate embodiment of the invention.

According to some embodiments, the first positively charged ion, the second positively charged ion or both are selected from the group consisting of: Li⁺, Na⁺, K⁺, Mg²⁺, Ca²⁺, Cl⁻, Br⁻, F⁻, NO₃⁻, Fe²⁺, Fe³⁺, CrO₄²⁻, Pb²⁺, Hg²⁺, Cd²⁺, In³⁺, Ru³⁺, Ru⁴⁺, Zn²⁺, Co²⁺, Co³⁺, Pt²⁺, Pt⁴⁺, Au⁺, Au³⁺, Ag⁺, Sn⁴⁺, Sn²⁺, Sn⁴⁻, and Cu²⁺. Each possibility represents a separate embodiment of the invention.

According to some embodiments, the at least one flow channel is formed by at least one of a separator, membrane, gasket, spacer, and salt bridge. The electrode capacitor assembly can further comprise a first current collector and a second current collector. In further embodiments, the first electrode is positioned between the first current collector and the flow channel, and the second electrode is positioned between the flow channel and the second current collector.

In certain embodiments, the first electrode, second electrode, or both comprise a flowable carbon electrode in the form of a suspension and/or a fluidized bed electrode.

In certain embodiments, the ionic solution flows in the flow channel directly through the electrodes, wherein the flow within the flow channel is configured orthogonally to the electrode surface plane.

According to some embodiments, the electrode capacitor assembly is in electrical communication with a power supply, wherein during operation said power supply is configured to apply electrical potential or to supply electric charge to the first and the second electrodes.

The electrode capacitor assembly can be a part of a wastewater treatment system, brackish water desalination system or chemical reactor. The water desalination system can be configured in a form of a Capacitive Deionization (CDI) system or a Membrane Capacitive Deionization System (MCDI). Each possibility represents a separate embodiment of the invention.

It is to be understood that any combination of each of the aspects and the embodiments disclosed herein is explicitly encompassed within the disclosure of the present invention.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

FIG. 1A: Schematic cross-sectional view of the electrode capacitor assembly, in accordance with some embodiments of the invention.

FIG. 1B: Schematic cross-sectional view of the macroscopic structure of the carbon electrode modified with negatively charged groups of the electrode capacitor assembly of FIG. 1A.

FIG. 1C: Schematic cross-sectional view of the micropores of the cathode modified with negatively charged groups of the electrode capacitor assembly of FIG. 1A, during operation.

FIG. 1D: Schematic cross-sectional view of the CDI system comprising the electrode capacitor assembly of FIG. 1A operating in a single-pass mode, in accordance with some embodiments of the invention.

FIG. 1E: Schematic cross-sectional view of the CDI system comprising the electrode capacitor assembly of FIG. 1A operating in a batch mode, in accordance with some embodiments of the invention.

FIG. 2A: Pore volume distribution of the pristine electrode (untreated electrode) and the oxidized (treated) electrode material.

FIG. 2B: Titration curves of the pristine electrode, the oxidized electrode, and a control sample without electrode material.

FIG. 3: Representative results from the CDI experiments with a pristine cathode (dashed line) and an oxidized cathode (solid line) in a single-pass charging mode and batch discharging mode.

FIG. 4: Conductivity vs. time overlay of CDI experiments conducted at 1 V for the pristine anode-oxidized cathode system (solid line) and the pristine anode-pristine cathode system (dashed line).

FIG. 5: Electrode surface charge (σ_{chem}) vs. pH for pre-experiment and post-experiment electrodes.

FIG. 6: Stern capacitance (C_{S}) fitting for pristine cathode-pristine anode and pristine anode-oxidized cathode electrode systems (measured data is represented by scattered points and Sc fitting is represented by lines).

FIG. 7: Salt adsorption capacity (SAC) with fitted C_{S} for the pristine anode-pristine cathode electrode system (measured data is represented by scattered points and Sc fitting is represented by lines).

FIG. 8: Salt adsorption capacity (SAC) with fitted C_{S} for the pristine anode-oxidized cathode electrode system (measured data is represented by scattered points and Sc fitting is represented by lines).

FIG. 9: Comparison of experimental separation factor (dots) with theoretical selectivity factor (continuous lines) with fitted C_{S} values.

FIGS. 10A-10B: Titration curves of pristine and acid-treated sulfonated electrodes (FIG. 10A—electrodes sulfonated by Procedures 1 and 2; FIG. 10B—electrode sulfonated by Procedure 4.

FIG. 11: Attenuated total reflection Fourier-transform infrared spectroscopy (ATR-FTIR) spectra of pristine and acid-treated sulfonated electrodes.

### DETAILED DESCRIPTION OF THE INVENTION

The present invention provides a method for selective separation of ionic species from an ionic solution based on said species ionic hydrated size. The inventors of the present invention have developed an advantageous electrode capacitor assembly comprising a first electrode and a second electrode, said electrodes comprising carbon having a pore structure comprising micropores, wherein the first electrode comprising carbon is modified with negatively charged surface groups and/or the second electrode comprising carbon is modified with positively charged surface groups. The present invention further relates to specific functional groups which provide long-term stability of negatively or positively charged carbon electrodes, thereby increasing the electrosorption capabilities of said modified electrodes towards ionic species having smaller hydrated radius.

Thus, according to a first aspect, the present invention provides a method for selective separation of ionic species from an ionic solution based on said species ionic hydrated size, the method comprising: (a) passing an ionic solution comprising at least a first ion and a second ion, said ions having distinct hydrated sizes, through an electrode capacitor assembly comprising: a first electrode and a second electrode, said electrodes comprising carbon having a pore structure comprising micropores, wherein the first electrode comprising carbon is modified with negatively charged surface groups and/or the second electrode comprising carbon is modified with positively charged surface groups, and at least one flow channel for the passage of the solution; and (b) applying an electric potential or charge to the first and the second electrodes.

According to some embodiments, during operation of the electrode capacitor assembly, said flow channel is in ionic contact with said first and/or said second electrodes.

In some embodiments, the first ion and the second ion are of the same polarity. The term “the same polarity”, as used herein, refers in some embodiments, to the first ion and the second ion both being either positively charged or negatively charged. It is to be understood that the term “the same polarity” refers only to the electric charge sign and does not require that the first ion and the second ion have the same ionic charge (or corresponding atom valency). For example, the first ion and the second ion being of the same polarity can be Li⁺ and Na⁺, as well as, Na⁺ and Mg²⁺.

According to some embodiments, the hydrated size of the first ion is smaller compared to the hydrated size of the second ion, by at least about 5%. According to further embodiments, the hydrated size of the first ion is smaller compared to the hydrated size of the second ion, by at least about 6%, about 7%, about 8%, about 9%, or about 10%. Each possibility represents a separate embodiment of the invention

The term “hydrated size” as used herein refers to the radius of a hydrated ion. The term “hydrated ion” refers to a soluble ion in the ionic solution. Typically, the hydration of an ion depends on the electrostatic attraction of water molecules to said ion, based on said ion density of charge. Since ions having smaller molar mass have greater ionic potential, they are able to attract more water molecules, thus resulting in bigger hydrated sizes. Therefore, there is an inverse relationship between non-hydrated radius and hydrated radius for a specific ion (Conway, B. E., “Ionic hydration in chemistry and biophysics”, 1981, Vol. 12. Elsevier Science Ltd., hereby incorporated by reference in its entirety).

According to some embodiments, the hydrated size of the first ion is smaller compared to the hydrated size of the second ion, by at least about 10%. In further embodiments, the hydrated size of the first ion is smaller compared to the hydrated size of the second ion, by at least about 15%, about 20%, about 30%, about 50%, about 70%, about 80%, about 90%, or about 95%. Each possibility represents a separate embodiment of the invention.

For example, the radius of the hydrated ion Li⁺ is about 3.8 Å, while the radius of the hydrated ion K⁺ is about 3.3 Å, therefore the radius of hydrated K⁺ is smaller by about 15% compared to the radius of hydrated Lit In some exemplary embodiments, the hydrated size of the first ion is smaller compared to the hydrated size of the second ion, by at least about 15%.

Without wishing to being bound by theory, the electrode capacitor assembly of the present invention comprising carbon electrodes with negatively and/or positively charged functional groups, provides enhanced adsorption of ionic species into the volume of the micropores on the surface of the electrodes. Ionic species having smaller ionic hydrated sizes become more effectively adsorbed in the micropores, as compared to ionic species having larger ionic hydrated sizes. Accordingly, in some embodiments, the method of selective separation of ionic species from an ionic solution provides an ionic solution, which is enriched in ionic species having larger ionic hydrated sizes relatively to ionic species of the same polarity having smaller ionic hydrated sizes, following the separation process. In certain such embodiments, the method of selective separation provides an ionic solution, which is enriched in ionic species having smaller ionic non-hydrated radii relatively to ionic species of the same polarity and ionic charge, which has larger ionic non-hydrated radii, following the separation process. According to further embodiments, the concentration of the first ion in the ionic solution, which passed through the electrode capacitor assembly during its operation is decreased to a higher extent as compared with the concentration of the second ion.

According to some embodiments, the electrode capacitor assembly of the present invention comprises carbon electrodes with negatively and/or positively charged fixed functional groups, The term “fixed functional groups”, as used herein, refers in some embodiments to the functional groups which remain attached to the carbon surface electrode following the capacitor operation at potentials above about 0.8V. In further embodiments, the term “fixed functional groups” refers to the surface coverage by said functional groups which is reduced by no more than about 1% following a single cycle of the capacitor operation at potentials above about 0.8V.

It should be understood that unless otherwise specified, the values of potentials or voltage indicated throughout the specification and in the claims refer to the potential of the first electrode measured versus the second electrode, or to the potential of the second electrode measured versus the potential of the first electrode, for a single electrode capacitor. If the electrode capacitor assembly is configured in a stack configuration, having multiple cells connected in series or in parallel, the indicated potential or voltage values refer to a single cell. The overall potential applied to the entire stack can be calculated as known in the art depending on how the cell are connected. The term “cell”, as used herein, refers to the electrode capacitor assembly comprising two electrodes and a flow channel there between.

In some embodiments, the first ion is a monovalent ion and the second ion is a polyvalent ion. Without wishing to being bound by theory, it is contemplated that the surface of the electrodes of the present invention is able to adsorb more selectively monovalent ions (having a single charge) than polyvalent ions (having multiple charges), such as, for example, divalent or trivalent ions, based on the hydrated size of said ions. In some related embodiments, the method of selective separation of ionic species from an ionic solution provides an ionic solution, which is enriched in polyvalent ions relatively to monovalent ions of the same polarity, following the separation process.

In some embodiments, the ionic solution further comprises a third ion, having a different hydrated size than the hydrated sizes of the first and the second ion. In some embodiments, the ionic solution further comprises additional ionic species, having hydrated sizes which are different than the hydrated sizes of the first and the second ions.

As disclosed hereinabove, the electrodes of the present invention comprise carbon and have a pore structure comprising micropores. In some embodiments, the pore structure of the electrodes further comprises macropores and/or mesopores. As used herein, the term “macropores” refers to pores having a diameter larger than about 50 nm. The macropores can be used as transport channels or tunnels, for the transport of ions from the bulk of the ionic solution into the micropores. As used herein, the term “mesopores” refers to pores having a diameter between about 50 nm to about 2 nm. As used herein, the term “micropores” refers to pores having a diameter smaller than about 2 nm. The micropores can be utilized as storage pores, for the adsorption of specific ionic species from the ionic solution.

As used herein, the terms “diameter” or “width” may be used interchangeably, and they refer to the length of the pore in the longest dimension thereof. The pores can have a shape selected from spherical, non-spherical, slit-shaped, polygon shapes, and combinations thereof.

In some embodiments, the micropores of the electrodes have a mean pore diameter of below about 2 nm. In further embodiments, the micropores have a pore diameter of below about 1.5 nm. In still further embodiments, the micropores have a pore diameter of below about 1 nm. In some embodiments, the micropores of the electrodes have a mean pore diameter ranging from about 0.5 nm to about 2 nm. In further embodiments, the micropores of the electrodes have a mean pore diameter ranging from about 0.7 nm to about 2 nm.

In some embodiments, the initial surface pH of the first electrode and/or the second electrode ranges from about 6 to about 8. In further embodiments, the initial surface pH of the first electrode and/or the second electrode ranges from about 6.5 to about 7.5. The term “initial surface pH” as used herein, refers in some embodiments, to the pH of the surface of the electrodes prior to the introduction of the ionic solution into the electrode capacitor assembly. In further embodiments, the term “initial surface pH” refers to the pH of the surface of the electrodes following the carbon electrode functionalization by negatively or positively charged surface groups.

In some embodiments, the first electrode has a surface charge of at least about 0.5 M at a pH of 8 or above. In further embodiments, the first electrode has a surface charge of at least about 1 M at a pH of 8 or above. In still further embodiments, the first electrode has a surface charge of at least about 2 M at a pH of 8 or above. In yet further embodiments, the first electrode has a surface charge of at least about 3 M at a pH of 8 or above.

In some embodiments, the electrode capacitor assembly is characterized by having a separation factor of above about 1.3, for the first ion and the second ion. In further embodiments, the electrode capacitor assembly is characterized by having a separation factor of above about 1.5, for the first ion and the second ion. In still further embodiments, the electrode capacitor assembly is characterized by having a separation factor of above about 2. In yet still further embodiments, the electrode capacitor assembly is characterized by having a separation factor of above about 2.5, above about 3, above about 3.5, above about 4, above about 4.5, or above about 5. In some exemplary embodiments, the electrode capacitor assembly is characterized by having a separation factor of above about 1.5.

The separation factor (also termed herein “β₁/β₂”) is calculated based on Equation I:

βᵢ=SACᵢ/C_{feed,i}, Equation I:

where SAC is the salt adsorption capacity and C_{feed} refers to the initial concentration of a specific ion having the integer: i. As used herein, the term “salt adsorption capacity” or “SAC” refers to the number of moles of a specific ion species which is adsorbed into the electrode surface. The term “electrode surface”, as used herein, is meant to encompass electrode pore surface. The ion βᵢ is defined to be the first (smaller) ion and the ion β₂ is defined as the second (larger) ion, based on their known hydrated ion radius in the ionic solution. Without wishing to being bound by theory, it is contemplated that the separation factor which is higher than 1 indicates that the ion having the smaller hydrated radius of the two ions is more selectively electrosorbed by the micropores on the surface of the electrode, as compared to the larger ion.

In some embodiments, the electrode capacitor assembly is characterized by having a separation factor of above about 1.3, for operating voltages of above 0.3 V, for the first ion and the second ion. In further embodiments, the electrode capacitor assembly is characterized by having a separation factor of above about 1.4, for operating voltages of above 0.8 V, for the first ion and the second ion. In still further embodiments, the electrode capacitor assembly is characterized by having a separation factor of above about 1.5, for operating voltages of above 1 V, for the first ion and the second ion. In yet still further embodiments, the electrode capacitor assembly is characterized by having a separation factor of above about 1.6, for operating voltages of above 1.1 V, for the first ion and the second ion.

Non-limiting examples of carbon-based materials suitable for use in the first electrode, the second electrode or both include activated carbon, carbon black, graphitic carbon, carbon fibers, carbon microfibers, carbon aerogel, carbon nanotubes (CNTs), graphene, carbide, carbon-based nanostructures such as fullerenic carbons or carbon onions, carbon paper and any combination thereof. The carbon fibers and/or microfibers can be woven into larger carbon filaments, fabrics, or sheets. The carbon paper can comprise carbon microfibers woven into flat sheets. In certain embodiments, the first electrode and the second electrode comprise activated carbon. In further embodiments, the first electrode and the second electrode comprise activated carbon fibers.

The first electrode, the second electrode, or both can comprise intercalation and/or redox-active materials blended with carbon. As used herein, the term “intercalation” refers to a reversible insertion of cations or anions into sites within the solid electrode material. A non-limiting example of a suitable intercalation-active material is graphite, which allows intercalation of potassium ions and/or lithium ions. Non-carbonaceous intercalation materials can be selected from sodium manganese oxide (NMO), transition metal hexacyanoferrates (MHCFs), two-dimensional (2D) transition metal carbides, carbonitrides and nitrides (MXenes), or molybdenum sulfide. Non-limiting examples of redox-active electrode materials include silver metal (for the Ag/AgCl redox reaction), sodium iron phosphate, two-dimensional layered titanium disulfide, bismuth-BiOCl, and metal oxychlorides such as VOCl and FeOCl. Additional information on the redox active materials suitable for use in combination with carbon-based electrodes can be found in Suss, M. E., et al. “Water desalination with energy storage electrode materials.” Joule 2.1 (2018): 10-15, hereby incorporated by reference in its entirety.

In some embodiments, the first electrode and/or the second electrode has a total pore volume ranging from about 0.1 mL/g to about 1 mL/g. In certain embodiments, the first electrode and/or the second electrode has a total pore volume of about 0.6 mL/g, for pores having a diameter of below about 2 nm.

Without wishing to being bound by theory or mechanism of action, it is contemplated that the electrode capacitor assembly of the present invention provides enhanced specific adsorption of specific ionic species. The enhanced specific adsorption is possible due to the presence of the negatively and/or positively charged surface groups, present on the surface of the micropores volume of the first and/or second electrode. When the first and/or the second electrode are charged via application of a cell voltage or current, said negatively and/or positively charged surface groups increase the electrical potential of the respective electrodes. Therefore, the negatively modified first electrode and/or the positively modified second electrode possess increased selective electrosorption capabilities towards specific ionic species. The enhanced selective electrosorption can be directed towards ions having smaller hydrated radius as compared to ions having larger hydrated radius, and/or towards ions having monovalent charge as compared to ions having polyvalent charge.

In some embodiments, the negatively charged surface groups of the first electrode are selected from the group consisting of carboxyl, lactone, quinone, sulfate, sulfonate, phosphate, nitro, halide, hydroxyl, ether, carbonyl groups, and combinations thereof. Each possibility represents a separate embodiment of the invention. In some embodiments, said surface groups include surface carbon atoms of the carbon electrode.

The term “carboxyl,” as used herein, refers to the group —C(═O)OH, which can be deprotonated at a suitable pH, and wherein C can refer to a surface atom of the carbon electrode.

The term “lactone”, as used herein, refers to the group —OC(═O)—, being a part of a substituted or unsubstituted hydrocarbon ring, wherein C can refer to a surface atom of the carbon electrode.

The term “quinone”, as used herein, refers to the group —C(═O)— group, being a part of a substituted or unsubstituted aromatic hydrocarbon, wherein C can refer to a surface atom of the carbon electrode.

The term “sulfate”, as used herein, refers to the group —O—S(═O)₂—O—R, where R can be selected from H, substituted or unsubstituted alkyl, aryl, alkenyl, alkynyl, and/or alkoxy moieties which may be linear, branched, or cyclic, and substituted or unsubstituted aryl and/or heteroaryl moieties.

The term “sulfonate”, as used herein, refers to the group —O—S(═O)₂—R, where R is as defined hereinabove.

The term “phosphate”, as used herein, refers to the group —O—P(═O)(OR)(OR) group, where R may be the same or different and independently selected as defined hereinabove.

The term “nitro” as used herein, refers to the group —NO₂.

The term “hydroxyl”, as used herein, refers to the group —OH.

The term “ether”, as used herein, refers to the group R—O—R, where R may be the same or different and independently selected as defined hereinabove.

The term “carbonyl”, as used herein, refers to the group R—(C═O)—R, where R may be the same or different and independently selected as defined hereinabove.

The halide group can be selected from fluoride (F⁻), chloride (Cl⁻), bromide (Br⁻) or iodide (I⁻). Each possibility represents a separate embodiment of the invention.

The inventors of the present invention have surprisingly discovered that in contrast to previously reported CDI electrodes, carboxyl surface groups were not stable at high operating voltages, which assumingly led to lower electrode selectivity than predicted by the theoretic model. The inventors have thus manufactured carbon electrodes functionalized with additional surface groups, which should be less pH dependent. Accordingly, in some embodiments, the first electrode comprising carbon is modified with negatively charged surface groups which are not pH dependent. In further embodiments, the negatively charged surface groups are selected from the group consisting of sulfonate, sulfate, phosphate, nitro, halide, and combinations thereof. In certain embodiments, the first electrode comprising carbon is modified with sulfonate groups, also termed herein “sulfonic” groups. In additional embodiments, the first electrode does not include carboxyl groups, as the main groups used for electrode surface modification. In further embodiments, the negatively charged functional groups include less than about 10% carboxyl groups out of the total concentration of functional groups of the first electrode. In yet further embodiments, the negatively charged functional groups include less than about 5% carboxyl groups out of the total concentration of functional groups of the first electrode. In still further embodiments, the negatively charged functional groups include less than about 1% carboxyl groups out of the total concentration of functional groups of the first electrode. In additional embodiments, the negatively charged functional groups do not include carboxyl groups.

In some embodiments, at least about 90% of the surface coverage by the negatively charged surface groups of the first electrode is retained following a single cycle of operation of the electrode capacitor. In further embodiments, at least about 95%, about 97%, or about 98% of the surface coverage by the negatively charged surface groups of the first electrode is retained following a single cycle of operation of the electrode capacitor. In some exemplary embodiments, at least about 99% of the surface coverage by the negatively charged surface groups of the first electrode is retained following a single cycle of operation of the electrode capacitor.

In some embodiments, the negatively charged surface groups are attached to the surface of the first electrode by covalent bonds.

In some embodiments, the first electrode has a surface area of above about 500 m²/g, based on nitrogen absorption measurements. In further embodiments, the first electrode has a surface area of above about 1000 m²/g, based on nitrogen absorption measurements.

In some embodiments, the first electrode comprising carbon is the cathode, wherein said cathode in modified by a chemical and/or physical treatment. In some embodiments, the chemical treatment of the surface of the first electrode comprises attaching negatively charged groups to the surface of the first electrode via a linker, a moiety, a tether, a long chain molecule, or combinations thereof. In some embodiments, anionic surfactants are used in order to attach negatively charged groups by adsorption of their linked hydrophobic groups onto carbon. Non-limiting examples of suitable anionic surfactants include sodium dodecyl benzene sulfonate, ammonium lauryl sulfate, sodium lauryl sulfate, sodium laureth sulfate, sodium myreth sulfate, dioctyl sodium sulfosuccinate, perfluorooctanesulfonate, perfluorobutanesulfonate, alkyl benzene sulfonates, alkyl aryl ether phosphate, alkyl ether phosphate, alkyl carboxylates, sodium stearate, sodium lauroyl sarcosinate, and fluorosurfactants, for example, perfluorononanoate (PFOA) or perfluorooctanoate (PFO). The negatively charged surface groups can further be formed by oxidation, amidation, or silanization.

According to some embodiments, the first electrode comprising carbon is modified with negatively charged sulfonate groups, by immersing said electrode in a solution comprising an anionic surfactant. In further embodiments, the anionic surfactant is sodium dodecyl benzene sulfonate (SDBS). Additional details on the modification procedure using anionic surfactants can be found in Oyarzun, D. I., et al. “Adsorption and capacitive regeneration of nitrate using inverted capacitive deionization with surfactant functionalized carbon electrodes” Separation and Purification Technology, 2018, 194: 410-415, hereby incorporated by reference in its entirety.

In some embodiments, the chemical treatment of the surface of the first electrode comprises exposure of the carbon material of the electrode to an oxidizing solution, such as, for example, nitric acid, sulfuric acid, or any other acid, as known in the art, and any combination thereof. In some exemplary embodiments, the chemical treatment of the surface of the first electrode comprises exposure of the carbon material to nitric acid.

According to some embodiments, the chemical treatment of the surface of the first electrode comprises reacting the carbon material with a diazonium salt. Preferably, said reaction is performed in the absence of an externally applied electric current and/or in a protic reaction medium.

According to some embodiments, the first electrode comprising carbon is sulfonated by immersing said electrode in sulfuric acid. According to some embodiments, the first electrode comprising carbon is sulfonated by immersing said electrode in nitric acid at a temperature ranging from about 20° C. to about 100° C. and then into sulfuric acid. In some embodiments, the temperature of nitric acid ranges from about 50° C. to about 100° C. In certain embodiments, the temperature of nitric acid is 80° C.

According to some embodiments, the first electrode comprising carbon is sulfonated with diazonium salt of sulfanilic acid, as detailed, for example, in U.S. Pat. No. 7,294,185, which is incorporated by reference herein in its entirety.

The physical treatment can include, inter alia, heating carbon electrode in an oxidizing atmosphere, such as, for example, oxygen and/or hydrogen peroxide. Additionally or alternatively, the carbon electrodes can be treated electrochemically to enrich their surface in negatively charged groups. The carbon electrodes can also be in-situ oxidized, by subjecting the electrodes to high potentials in aqueous environments.

In some embodiments, the negatively charged surface groups are attached to the electrode surface by derivatization of a pristine or treated electrode.

In certain embodiments, the first electrode comprising activated carbon is the cathode, wherein said cathode in modified by oxidation or chemical treatment. In further embodiments, the first electrode comprises carbon modified with sulfonate surface groups.

In some embodiments, the second electrode comprising activated carbon is the anode, wherein said anode is not chemically modified. In certain such embodiments, the second electrode is not positively or negatively charged prior to the introduction of the ionic solution into the electrode capacitor assembly. The term “not charged”, as used herein, refers in some embodiments, to the surface charge being lower than about 0.2M.

In some embodiments, the second electrode comprising activated carbon is the anode, wherein said anode is chemically modified. In some embodiments, the second electrode comprising carbon is modified with positively charged surface groups, said positively charged surface groups being selected from the group consisting of: amine, amide, and any other group, as known in the art.

The term “amine”, as used herein, refers to the group —NR₃ or —NR₄⁺, wherein each R may be the same or different and independently selected as defined hereinabove.

The term “amide,” as used herein, refers to the group —C(═O)NR— or —NRC(═O)—, wherein R is as defined hereinabove.

In some embodiments, the amine is selected from ammonia, primary amine, secondary amine, tertiary amine, quaternary amine, and combinations thereof. Each possibility represents a separate embodiment of the invention. In certain embodiments, the amine is a quaternary amine. A non-limiting example of a suitable amine group is ethylenediamine. Non-limiting examples of suitable amide groups include phosphoramide or carboxamides such as acetamide or benzamide.

In some embodiments, at least about 90% of the surface coverage by the positively charged surface groups of the second electrode is retained following a single cycle of operation of the electrode capacitor. In further embodiments, at least about 95%, about 97%, or about 98% of the surface coverage by the positively charged surface groups of the second electrode is retained following a single cycle of operation of the electrode capacitor. In some exemplary embodiments, at least about 99% of the surface coverage by the positively charged surface groups of the second electrode is retained following a single cycle of operation of the electrode capacitor.

In some embodiments, the positively charged surface groups are attached to the surface of the second electrode by covalent bonds. In further embodiments, the positively charged surface groups are attached to the surface of the second electrode by a linker, moiety, tether, long chain molecule, or combinations thereof. In some embodiments, cationic surfactants are used in order to attach positively charged groups by adsorption of their linked hydrophobic groups onto carbon. Non-limiting examples of suitable cationic surfactants include octenidine dihydrochloride, alkyltrimethylammonium salts, cetyl trimethylammonium bromide (CTAB), cetyl trimethylammonium chloride (CTAC), cetylpyridinium chloride (CPC), polyethoxylated tallow amine (POEA), benzalkonium chloride (BAC), benzethonium chloride (BZT), 5-bromo-5-nitro-1,3-dioxane, dimethyldioctadecylammonium chloride, and D\dioctadecyldimethylammonium bromide (DODAB).

In some embodiments, the second electrode comprising carbon is the anode, wherein said anode in modified by a chemical and/or physical treatment. In some embodiments, the chemical treatment of the surface of the second electrode comprises attaching positively charged groups to the surface of the second electrode via a linker, a moiety, a tether, a long chain molecule, or combinations thereof.

In some embodiments, the chemical treatment of the surface of the second electrode comprises immersing the second electrode in an acid solution, such as nitric acid, followed by immersing the second electrode in a basic solution, such as ethylenediamine (EDA). In further embodiments, the acid solution, the basic solution, or both, are heated to a temperature of above about 90° C., above about 95° C., or above about 100° C., under atmospheric pressure.

The positively charged surface groups can further be formed by a reduction reaction performed on the surface of the carbon electrode. In certain embodiments, the second electrode is modified by reduction of carbon with hydrogen or sodium borohydride (NaBH₄). Reduction of the carbon electrode can be preceded by an oxidation step, as detailed hereinabove. The positively charged surface groups can further be formed by heating the carbon electrode under vacuum at elevated temperatures, such as about 1000° C. Additional information on the reduction of carbon electrodes can be found in Cohen I, et al. “Enhanced charge efficiency in capacitive deionization achieved by surface-treated electrodes and by means of a third electrode”. The Journal of Physical Chemistry C, 2011, 115.40: 19856-19863, hereby incorporated by reference in its entirety.

In some embodiments, the positively charged surface groups are attached to the electrode surface by derivatization of a pristine or treated electrode.

In some embodiments, the modified second electrode has a surface area of above about 500 m²/g. In further embodiments, the modified second electrode has a surface area of above about 1000 m²/g.

In some embodiments, the first electrode comprising activated carbon is the cathode, wherein said cathode is not chemically modified, while the second electrode is the anode, wherein said anode is chemically modified, as presented herein above.

The method of the present invention comprises step (b), which comprises applying an electric potential or charge to the first and the second electrodes. In certain embodiments, step (b) comprises applying electric potential between the first and the second electrodes. In further embodiments, said potential induces charging of the capacitor electrode assembly. In additional embodiments, said potential induces discharging of the capacitor electrode assembly. The term “applying charge”, as used herein, is also meant to encompass drawing charge from the electrode capacitor assembly.

In further embodiments, step (b) comprises applying a potential of above about 0.8V. In yet further embodiments, step (b) comprises applying a potential of above about 1V. In still further embodiments, step (b) comprises applying a potential of above about 1.2V.

The capacitor electrode assembly can be charged and/or discharged in a single-pass charge mode, wherein the ionic stream which exits the capacitor electrode assembly is discarded. The capacitor electrode assembly can be charged and/or discharged in a batch mode, wherein the ionic stream which exits the capacitor electrode assembly is recycled back to the feed tank.

According to some embodiments, the method comprises continuous passing of the ionic solution through an electrode capacitor assembly while the electric potential is applied to the electrode capacitor assembly. The term “continuous”, as used herein, refers in some embodiments to recirculation of the ionic solution through the feed tank, following its flow from the capacitor electrode assembly. The ionic solution can be recirculated two, three, five, ten or more times.

In some embodiments, the ionic solution which can be selectively deionized by the method of the invention includes monovalent ions. In further embodiments, said solution comprises polyvalent ions. In some embodiments, the ionic solution of the present invention comprises ionic species, which are selected from the group consisting of Li⁺, Na⁺, K⁺, Mg²⁺, Ca²⁺, Cl⁻, Br⁻, F⁻, NO₃⁻, Fe²⁺, Fe³⁺, CrO₄²⁻, Pb²⁺, Hg²⁺, Cd²⁺, In³⁺, Ru³⁺, Ru⁴⁺, Zn²⁺, Co²⁺, Co³⁺, Pt²⁺, Pt⁴⁺, Au⁺, Au³⁺, Ag⁺, Sn⁴⁺, Sn²⁺, Sn⁴⁻, Cu²⁺, and combinations thereof. Each possibility represents a separate embodiment of the invention. The ionic solution can also comprise amine ions, selected from ammonia, primary amine, secondary amine, tertiary amine, quaternary amine, and combinations thereof. In some embodiments, the ionic solution comprises quaternary ammonium salts or quaternary ammonium compounds. In further embodiments, the quaternary ammonium salts or quaternary ammonium compounds comprise at least one alkyl group or an aryl group. The term “amine” is as defined hereinabove.

In some embodiments, the ionic solution comprises ionic species selected from the group consisting of Li⁺, Na⁺, K⁺, Cl⁻, Br⁻, F⁻, and combinations thereof. In certain embodiments, the first ion in the ionic solution is K⁺ and the second ion is Li⁺.

In some embodiments, the ionic solution further comprises water or an organic solvent. In some exemplary embodiments, the ionic solution is an aqueous solution. The aqueous based solution can further include a buffer, osmolarity agent or ionic strength modifier.

In some embodiments, the ionic solution comprises glucose.

In some embodiments, the ionic solution is organic-based. Non-limiting examples of suitable organic solvents include propylene carbonate, propylene glycol, acetonitrile, tetrahydrofuran, diethyl carbonate, γ-butyrolactone, and combinations thereof.

In some embodiments, the at least one flow channel for the passage of the solution separates the first and the second electrodes. In some embodiments, the at least one flow channel is formed by at least one of a separator, membrane, gasket, spacer, salt bridge, and any combination thereof.

The capacitor assembly of the present invention as presented herein above can be configured in various cell geometries, as known in the art. In some embodiments, the electrode capacitor assembly is operated in a flow-by mode, wherein the capacitor assembly is configured in a stack configuration, having a spacer separating the electrodes, wherein the ionic solution flows through the spacer in a horizontal manner, parallel to the electrodes. In further embodiments, the first electrode is positioned between said first current collector and the flow channel, and the second electrode is positioned between the flow channel and said second current collector.

In some embodiments, the electrode capacitor assembly is operated in a flow-by mode utilizing flow-electrodes. In such embodiments, the capacitor assembly comprise at least two electrode channels, wherein each electrode channel comprise a flowable carbon electrode in the form of a suspension (slurry) and/or a fluidized bed electrode. The at least two electrode channels are in ionic contact with at least two ion-permeable membranes, which separate the carbon electrodes from the ionic solution flowing through the flow channel. Each flowable carbon electrode flow through the electrode channel, which separate the membrane from the current collector.

In some embodiments, the electrode capacitor assembly is operated in a flow-through mode, wherein the ionic solution flows in the flow channel directly through the electrodes, wherein the flow channel is configured orthogonally to the electrodes. In further such embodiments, the ionic solution flows through the interconnected pores of the porous carbon electrodes. As used herein, the term “interconnected pores” refers to a porous carbon material having an open porosity, wherein the pores of the material are connected, thus enabling the passage of a fluid from the bulk to the internal volume of the pores within the carbon material.

According to some embodiments, the electrode capacitor assembly of the present invention as presented herein above is in electrical communication with a power supply, wherein during operation said power supply is configured to apply electrical potential or to supply charge to the first and the second electrodes.

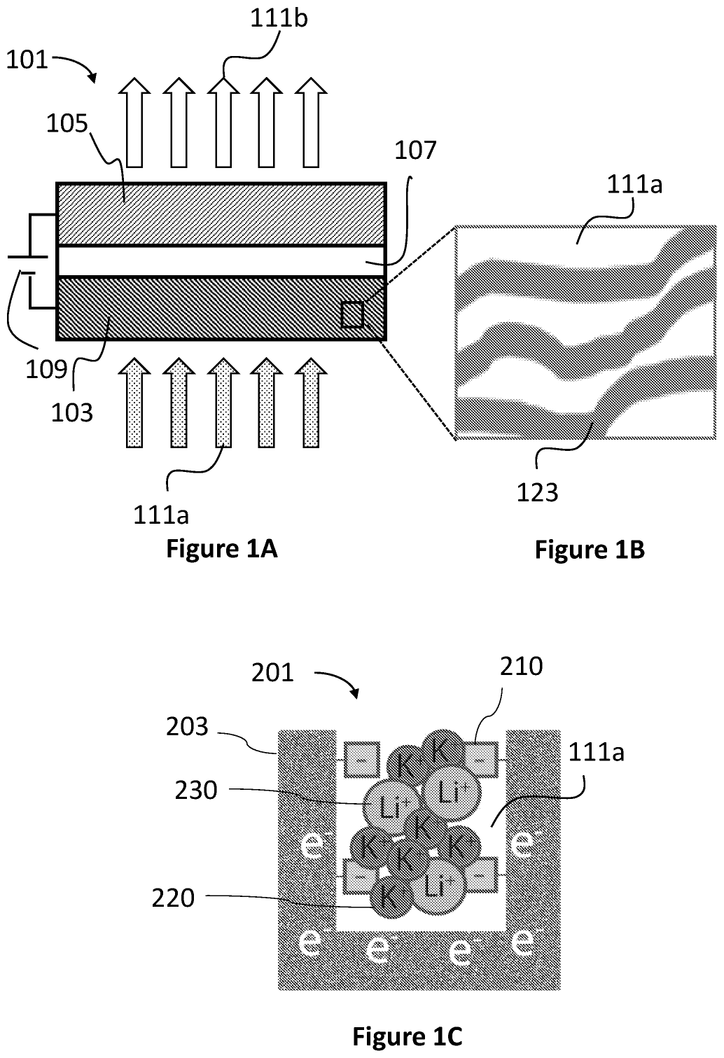

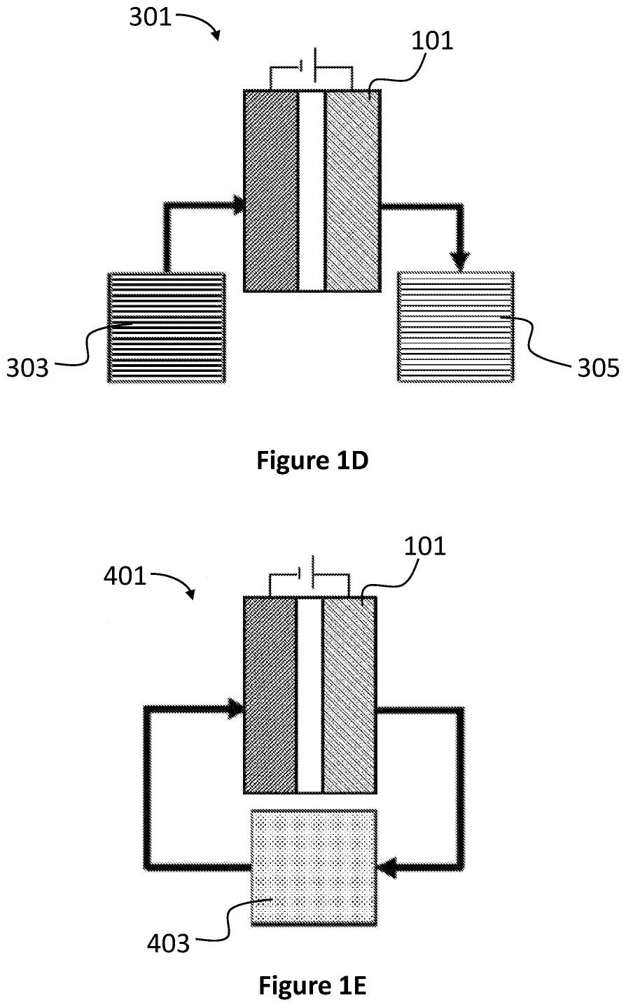

Reference is now made to FIG. 1A, which schematically represents a cross-sectional view of capacitor electrode assembly 101, for use in the method of selective separation of ionic species, according to some embodiments of the invention. Capacitor electrode assembly 101 includes first electrode (cathode) 103, which contains carbon modified with negatively charged surface groups. Capacitor electrode assembly 101 further includes second electrode (anode) 105, which contains carbon, which can be modified with positively charged surface groups. Capacitor electrode assembly 101 further includes flow channel 107 disposed between first electrode 103 and second electrode 105. First electrode 103 and second electrode 105 are connected to power supply 109.

Electrode capacitor assembly 101 is operated in a flow-through mode, wherein ionic solution 111a enters capacitor electrode assembly 101 through first electrode 103, flows through flow channel 107 and exits capacitor electrode assembly 101 through second electrode 105 as ionic solution 111b, wherein the flow is configured orthogonally to the electrodes surface plane.

Reference is now made to FIG. 1B, which schematically represents the cross-sectional view of the macroscopic structure of first electrode 103 of electrode capacitor assembly 101, as presented in FIG. 1A, according to some embodiments of the invention. First electrode 103 contains carbon modified with negatively charged surface groups, wherein carbon is in a form of carbon fibers 123, which create macropores therebetween for the passage of ions from the bulk of ionic solution 111a into the micropores.

Reference is now made to FIG. 1C, which schematically represents a cross-sectional view of micropore 201 of the carbon fibers of first electrode 103 comprising negatively charged surface groups, during charging of the electrode capacitor assembly, according to some embodiments of the present invention. First electrode 103 has a pore structure comprising micropores including micropore 201, which surface is modified with negatively charged surface groups 210. Ionic solution 111a comprising first ion species 220 which is K⁺, and second ion species 230 which is Li⁺ is passed through the electrode capacitor assembly. First ion 220 (K⁺) has a smaller hydrated radius than second ion 230 (Li⁺). When electric potential is applied to first electrode (cathode) 103, negatively charged surface groups 210 increase the electric charge of the cathode, and the selective adsorption of first ion species 220 in the micropore 201 volume is enhanced compared to the adsorption of second ion species 230, having larger hydrated size.

In some embodiments, the electrode capacitor assembly of the present invention further comprises a first current collector and a second current collector. In further embodiments, the electrode capacitor assembly comprises additional electrodes and/or current collectors. In yet further embodiments, the electrode capacitor assembly comprises additional flow channels.

According to some embodiments, the electrode capacitor assembly is incorporated within a brackish water desalination system. In some embodiments, the water desalination system is configured in a form of a Capacitive Deionization (CDI) system or a Membrane Capacitive Deionization System (MCDI). The CDI and/or MCDI systems can further be used in additional applications, including, inter alia, water softening, wastewater treatment, irrigation, and organic stream remediation. The method of the present invention can therefore be used to selectively separate ions in ionic solutions intended for agricultural or consumer purposes. It should be emphasized that the present method eliminates the need for mineral reintroduction step of reverse osmosis (RO) systems. CDI is also a more energy efficient process than RO for treating brackish and wastewater streams and is a more scalable technology. Selective removal of specific ion species afforded by the method of the invention further simplifies and increases efficiency of the capacitive deionization process for water treatment.

In some embodiments, the flow channel comprises at least two ion-permeable membranes. The term “Membrane Capacitive Deionization” or “MCDI” as used herein refers to a modified form of CDI, which employ the utilization of at least two ion exchange membranes, which separate the electrodes from the ionic solution, and enable the passage of ions having specific charge from the solution to the electrode.

In further embodiments, the CDI and or MCDI system further comprises a feed tank, a feed pump, and/or a waste tank.

Reference is now made to FIG. 1D, which schematically represents a cross-sectional view of CDI system 301 comprising electrode capacitor assembly 101 operating in a single-pass mode, in accordance with some embodiments of the invention. CDI system 301 further includes feed tank 303 and waste tank 305. In the single-pass mode during charging, the ionic solution passes from feed tank 303 through capacitor electrode assembly 101 cell and then into waste tank 305.

Reference is now made to FIG. 1E, which schematically represents a cross-sectional view of CDI system 401 comprising electrode capacitor assembly 101 operating in a batch mode, in accordance with some embodiments of the invention. CDI system 401 further includes feed tank 403. In the batch mode, the ionic solution passes from feed tank 403 through capacitor electrode assembly 101 and is then recycled back to feed tank 403.

According to some embodiments, the electrode capacitor assembly is utilized for chemical separations and/or synthesis processes. For example, the electrode capacitor assembly can be utilized for obtaining solutions which contain high concentrations of Li ions by adsorbing smaller salts ions, for Li recovery applications.

In yet still embodiments, the electrode capacitor assembly is incorporated within a chemical reactor. The method of the present invention can therefore be used to selectively separate ions following chemical synthesis.

According to another aspect, there is provided a method for the modification of the first electrode of the present invention, via an oxidation treatment. In some embodiments, the first electrode comprising carbon is modified with negatively charged surface groups, by a chemical treatment, wherein the chemical treatment comprises oxidation. In some embodiments, the oxidation is performed by immersing the first electrode in an acid, selected from the group consisting of: nitric acid, sulfuric acid, or any other acid as known in the art. In some exemplary embodiments, said acid is nitric acid.

In some embodiments, the chemical treatment of the first electrode further comprises a washing step, in which the first electrode is washed with an alkaline solution, salt solution, deionized water, or any combination thereof. In some embodiments, the first electrode is washed until the surface pH of the first electrode reaches about 6.5 to about 7.5. In some embodiments, the first electrode is washed with a salt solution until the surface pH of the first electrode reaches about 5.5 to about 6.5, and then washed with deionized water until the surface pH of the first electrode reaches about 6.5 to about 7.5. In some embodiments, the salt solution comprises a bicarbonate ion (HCO₃⁻), such as sodium bicarbonate.

In some embodiments, the chemical treatment of the first electrode further comprises a drying step, in which the first electrode is dried at a temperature of about 50 to about 200° C., for a duration of about 1 to about 50 hours. In certain embodiments, during the drying step the first electrode is dried at a temperature of about 50 to about 100° C., for a duration of about 1.5 to about 30 hours.

As used herein and in the appended claims the singular forms “a”, “an,” and “the” include plural references unless the content clearly dictates otherwise. It should be noted that the term “and” or the term “or” is generally employed in its sense including “and/or” unless the content clearly dictates otherwise. Throughout the description and claims of this specification, the words “comprise” and “contain” and variations of the words, for example “comprising” and “comprises”, mean “including but not limited to”, and are not intended to (and do not) exclude other moieties, additives, components, integers or steps.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed methods.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1: Oxidized Electrode Preparation

The electrodes were composed of squares of an activated carbon cloth (ACC-5092-15, Kynol Europa GmbH). Each cloth had a thickness of about 500 μm, and a surface area of 1500 m²/g (via BET analysis).

For the anode, the electrode material was used as-received from the manufacturer without any chemical pre-treatment. Throughout the examples, such anode is referred to as “pristine”.

As for the cathode, the electrode material was subjected to an oxidation treatment. Throughout the examples, such cathode is referred to as “oxidized”. The electrode was immersed in 70 wt % nitric acid for 24 hours, and then then washed in 0.1 M sodium bicarbonate until the surface pH reached approximately 6 (measured with qualitative pH strips). The electrode was then washed with deionized water until the surface pH reaches 7, and dried in air at 80° C. overnight in a circulating oven.

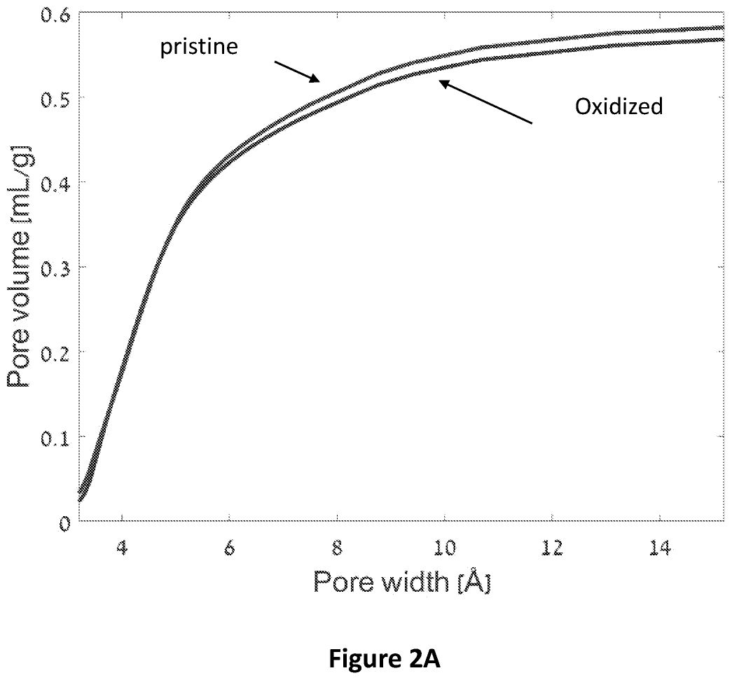

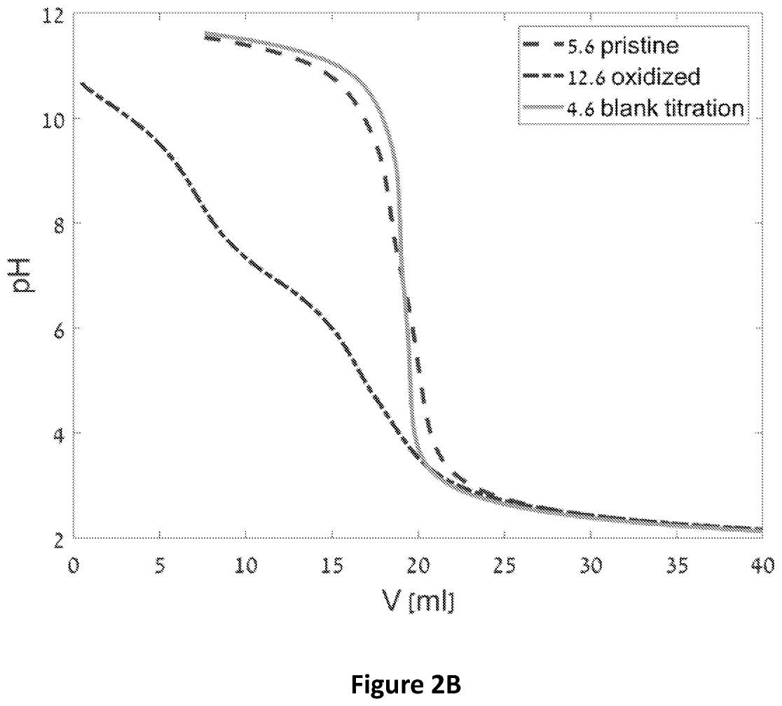

The total pore volume for both the anode (termed herein “pristine”) and the cathode (termed herein “oxidized”) was about 0.6 mL/g, calculated based on nitrogen gas sorption. The pore distribution is shown in FIG. 2A.

### Example 2: Chemical Surface Charge of the Oxidized Electrode

The surface charge of pristine electrode and the oxidized electrode was determined via pH titration. The electrodes were ground in a mortar and pestle, then added to a vessel containing 0.05 M HCl (7.6 mL for pristine electrode, 0.5 mL for oxidized electrode), 0.05 M NaOH (19.35 mL), and deionized water (62 mL). The solution was nitrogen-sparged, sealed, and then stored for 5 days under stirring. The solution was then transferred to a titration system (Titrando 904 and iAquatrode Plus Pt1000, Metrohm AG, Herisau, Switzerland) and titrated utilizing 0.05 M HCl under a nitrogen atmosphere.

The results were compared to a control titration sample, which did not contain any electrode material and only contained the same acid and base solutions at the same concentrations as the other samples.

It can be seen from the titration curves (FIG. 2B) that the oxidized electrode is more pH sensitive at various points throughout the titration, than the pristine electrode and the control titration sample.

### Example 3: CDI Cell Configuration

Each electrode was composed of four squares of the activated carbon which were stacked to form a single electrode, wherein each square had the dimensions of 1.75×1.75 cm², and weighted about 0.06 g. All of the squares were soaked in solutions of ethanol and deionized water with ethanol volume fractions of 0.7, 0.5, 0.3, and 0 (pure water), in order to wet the micropores on the surface of the carbon structure.

The CDI cell (also termed herein “capacitor electrode assembly”) was composed of two electrodes, which were electronically isolated from each other by a porous separator (Whatman 2 cellulose filter paper, GE Life Sciences, 2.4×2.4 cm²). The CDI cell was operated utilizing a flow-through mode, wherein the feed solution flowed in the porous separator directly through the electrodes. The anode and the cathode were respectively connected to the negative and positive terminals of a voltage source (2400 Source Meter, Keithley Instruments, Langley, Berkshire, England).

Two cell configurations were used: in the first, both electrodes were pristine (termed “pristine-pristine system”), and in the second, the electrode held at negative potential (the cathode) was oxidized while the electrode held at positive potential (the anode) was pristine (termed “pristine-oxidized system”).

### Example 4: CDI Experimental Procedure and Selectivity Assessment

The feed solution which entered the CDI cell contained 2 mM of analytical-grade KCl (Merck Millipore KGaA, Darmstadt, Germany), 2 mM of analytical-grade LiCl (Acros Organics, Geel, Belgium), and deionized water. The solution was purged with nitrogen gas in a 0.5 L glass reservoir until the dissolved oxygen content was approximately 5% of saturation (measured with an Orion Star A213, Thermo Fisher Scientific, Waltham, Mass., USA).

The feed solution was then pumped by a peristaltic pump (Masterflex 07551-30, Cole Parmer, Barrington, Ill., USA) at a rate of 1 mL/min into the CDI cell.

Single-Pass Charging Configuration

Five cycles of 30 min charging at a constant voltage and 30 min discharging at 0 V were executed in a single-pass charging configuration, where the cell effluent (the stream exiting the CDI cell) passes through a conductivity sensor (Tracedec 390-50, Innovative Sensor Technologies GmbH, Strasshof, Austria) before entering a waste container, in order to condition the electrodes and reach a limit cycle behavior.

Batch Charging Configuration

Next, charging was carried out in the same manner and at the same voltage as detailed above, with the exception that charging continued until an equilibrium state was reached (either 2 or 2.5 hours). At equilibrium, the system was switched to a batch charging configuration with 9 mL of continuously-circulating solution initially consisting of feed water, of which 4 mL was contained in a small, continuously-stirred reservoir. The cell was then discharged until the current magnitude was less than 0.1 mA, and the solution conductivity was stable. The charge/discharge process was executed at least three times for charging voltages 0.4-1.2 V in steps of 0.2 V for both pristine-pristine and oxidized-pristine electrode configurations. The electrodes were replaced each time the electrode configuration or the charging voltage was changed.

The collected batch solutions were mixed with deionized water, and an ionic strength adjuster (ISA) was added in a ratio of 1 mL to 50 mL solution/DI mixture. An additional reference solution was prepared with feed solution in the above manner. The potassium concentrations of the reference and sample solutions are measured with a potassium ion-selective electrode (6.0510.110, Metrohm) via direct measurement and corrected for temperature variations. All solutions were measured at least twice and the electrodes were immersed in deionized water for 20 seconds between measurements.

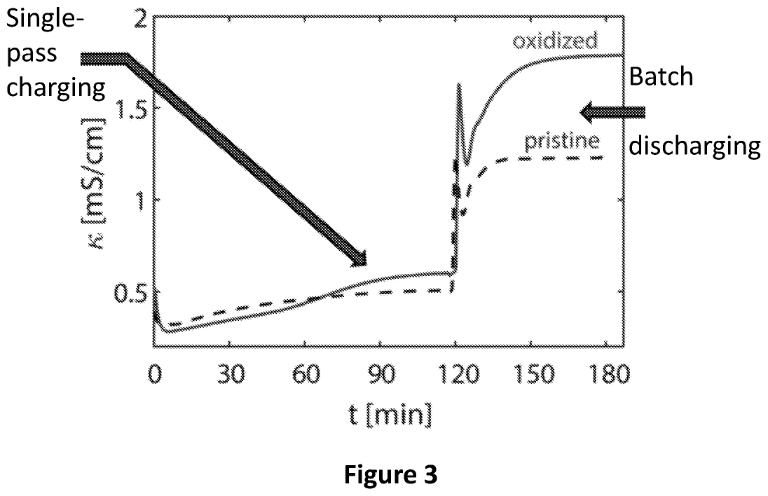

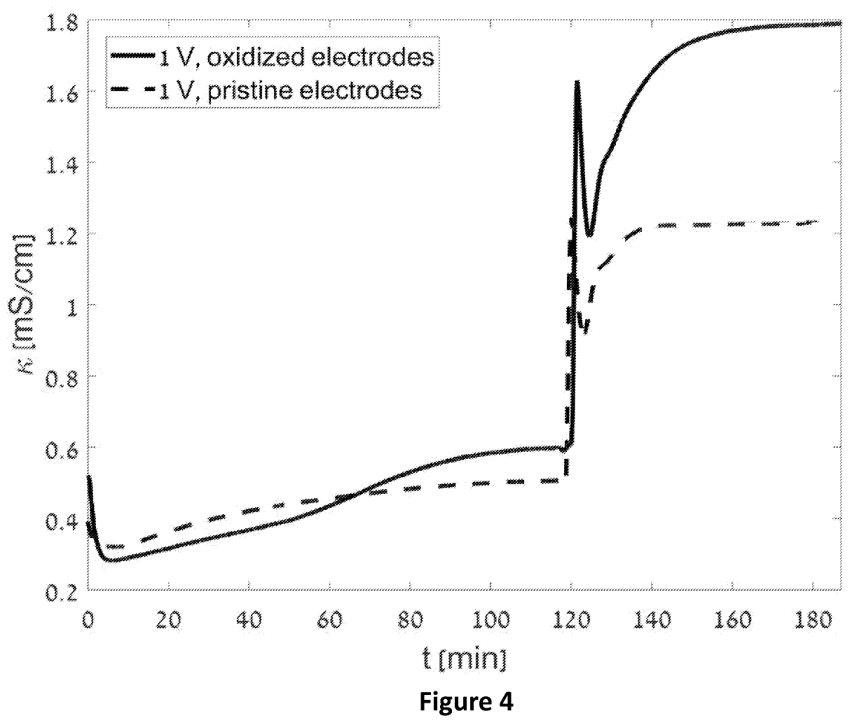

Representative results from the CDI experiments with a pristine and an oxidized cathode in the single-pass charging mode at 1V and the batch discharging mode at 0V until discharge is complete are shown at FIG. 3, while a comparison of conductivity vs. time for the pristine-oxidized system and the pristine-pristine system is shown at FIG. 4. A spike in FIG. 3 appears upon discharge (just after t=120 min) due to the rapid salt desorption from the micropores immediately upon shorting the electrodes. The increase in the final conductivity of the oxidized cathode system relative to the pristine cathode system in FIG. 4 indicates a higher overall salt storage capacity.

### Example 5: Surface Charge and Storage

The surface charge σ_{chem} of the activated carbon electrodes was determined by a comparison of the titration curves (FIG. 2B) of a sample containing an electrode, to that of a control sample without the electrode (i.e. a “blank” titration). The surface charge σ_{chem} was calculated based on the titration curves via Equation II:

$${σ}_{chem} = \frac{c Δ V}{{m}_{elec} {v}_{mi}} , \qquad Equation II$$

Where:

m_{elec} is the electrode mass (grams);

vₘᵢ is the specific electrode micropore volume (mL/g electrode);

c is the titrant concentration; and

ΔV=V_{electrode}−V_{blank} is the difference in titrant volume added compared to the control sample, at the same measured pH.

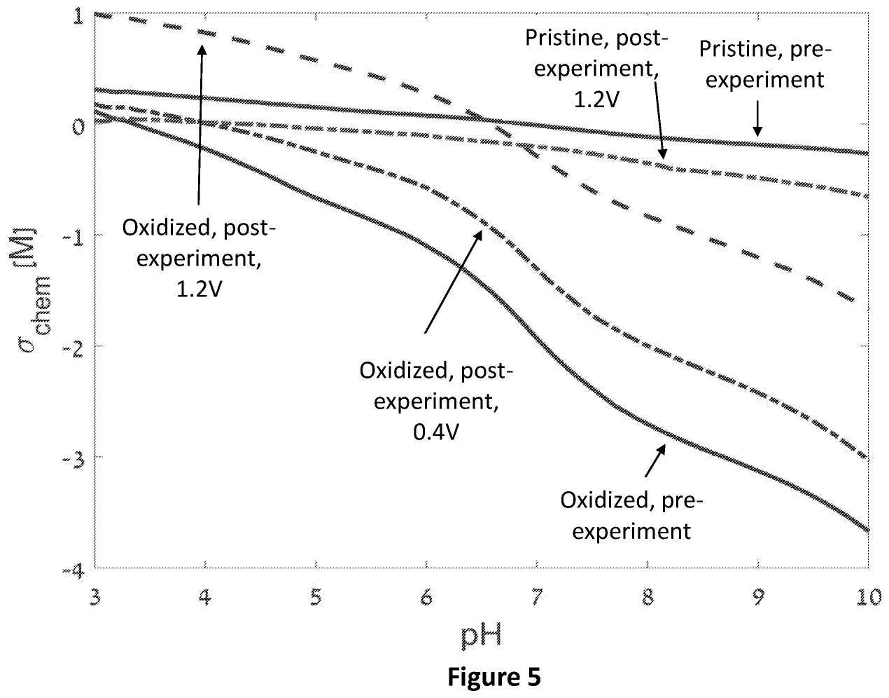

The chemical surface charge (in mol/liter micropores) as a function of pH is shown in FIG. 5. The surface charge of the pristine electrode varied weakly with pH, while the oxidized electrode surface charge varies strongly with pH, indicating a large presence of surface groups on the latter. Post-experiment titrations of each electrode type show that the surface charge of the cathode increased as a result of CDI cycling, relative to the pre-experiment electrode.

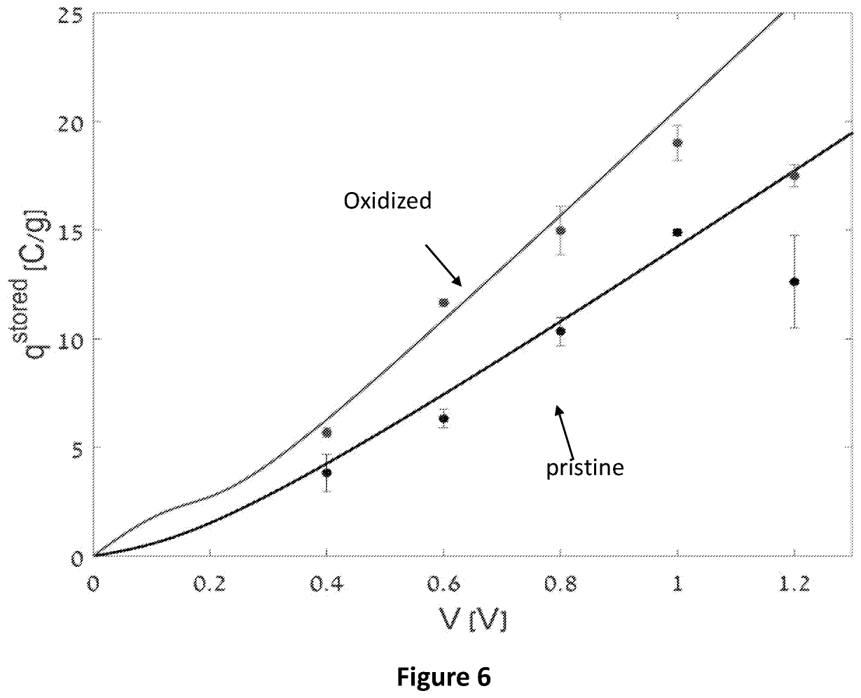

The charge storage (q^{stored}) for potassium and lithium of the pristine-pristine and pristine-oxidized electrode cells is shown in FIG. 6, where C_{S} (Stern capacitance) was chosen in order to provide an ideal fit to the data: C_{S} (pristine)=95 F/mL, and C_{S} (oxidized)=135 F/mL.

The lithium concentration was calculated by Equation III:

$${c}_{LiCl} = {c}_{{li}^{+}} = \frac{K - {c}_{KCl} {⩓}_{KCl}}{{⩓}_{LiCl}} . \qquad Equation III$$

Where:

κ=κ_{LiCl}+κ_{KCl}, since the lithium concentration in the batch samples was determined by assuming that the KCl and LiCl contributions to the solution conductivity were independent;

C_{KCL} is the KCl concentration; and

equivalent conductivities Λ_{KCl} and Λ_{LiCl} were derived from the literature (Vanýsek, P. Equivalent conductivity of electrolytes in aqueous solution. CRC Handbook of Chemistry and Physics 76 (2013)).

The charge storage (q^{stored}) as a result of a full CDI cycle at a particular charging voltage was calculated by Equation IV:

qⱼ^{stored}=qⱼ−qⱼ⁰, Equation IV

Where:

qⱼ⁰ is the electrode charge at ϕ_{elec}=0; and

φ_{elec} is defined as the voltage of the electrode.

Equation III was obtained via the assumption of infinite solute dilution. However, the deviation from ideality at an ionic strength of about 5 mM was small, and it was seen from the calculations of the feed solution lithium concentration that appropriate values of the equivalent conductivities Λ_{KCl} and Λ_{LiCl} satisfactorily corrected this error.

It can be seen from FIG. 6 that the oxidized electrode had higher charge storage (q^{stored}) for potassium and lithium ions at all the measured potentials as compared to the pristine electrode.

### Example 6: CDI Cell Parameters

The salt adsorption capacity (SAC) of the electrodes, i.e. the number of moles of an ion species i stored in the electrode is determined experimentally via Equation V:

$$S A {C}_{i} = \frac{{V}_{batch}}{{m}_{elec}} ( {c}_{dischare , i} - {c}_{feed , i} ) . \qquad Equation V$$

Where:

V_{batch}/M_{elec} is the feed solution flow rate;

C_{discharge} is the concentration of ion i in the cell effluent during the charge step; and

C_{feed} is the feed concentration of ion i.

SACᵢ is obtained from the measurements of the concentration of ion i in the cell effluent during the charge step in a single-pass experiment, which when subtracted from the feed concentration, integrated in time, and multiplied by feed flow rate, gives the total moles of ion i removed from the feed. The charge step when measuring SACᵢ generally begins with an uncharged electrode and ends at cell equilibrium.

Selecting the appropriate pH to determine σ_{chem} was a nontrivial manner, as strong pH variations have been observed in CDI systems during charging, and pH is different on the anode and cathode. Therefore, the surface charge was used as a fitting parameter to give the best fit of the data.

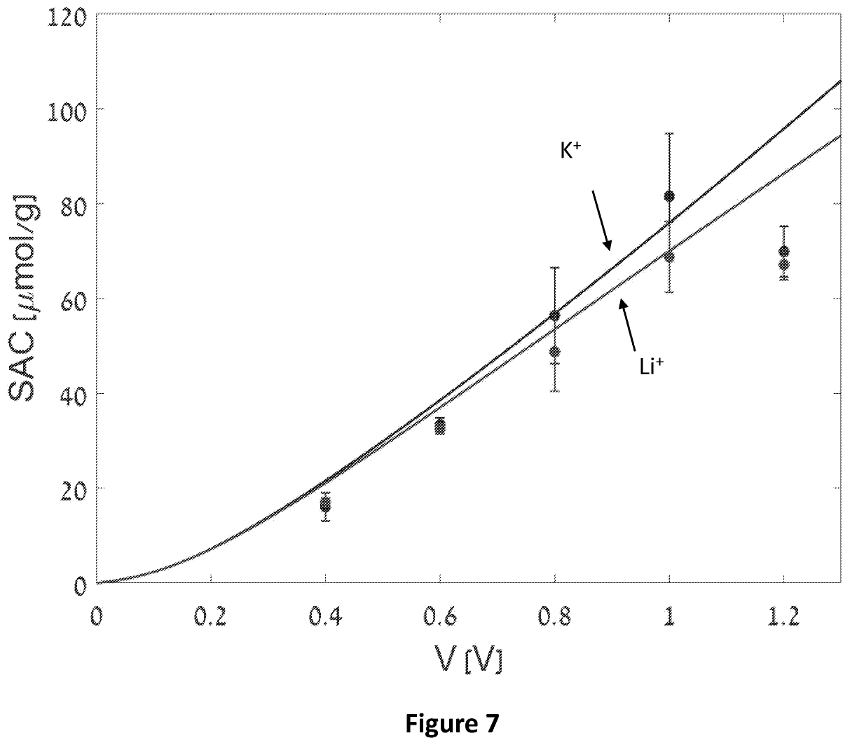

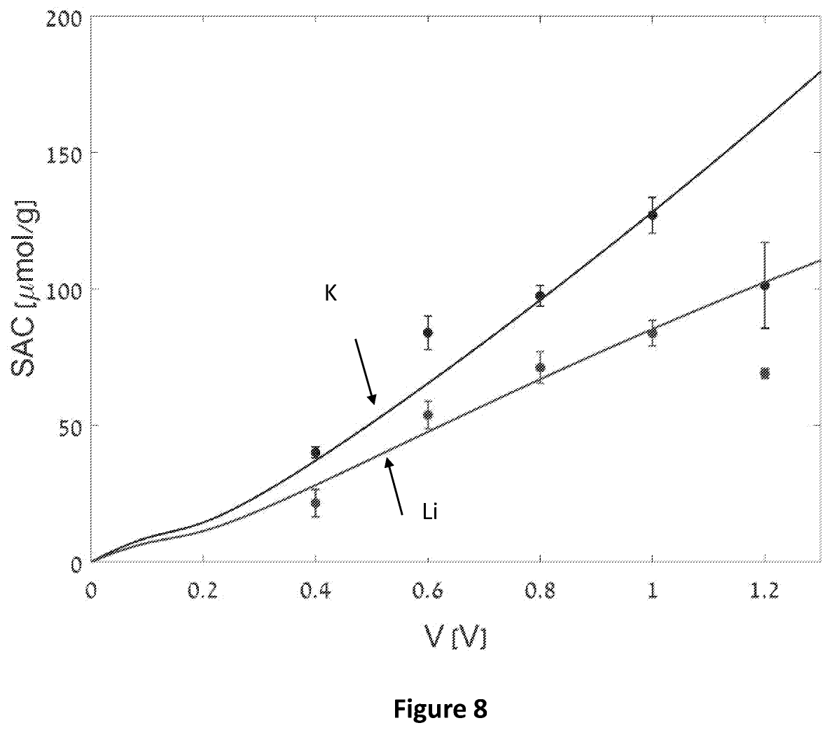

The experimental and theoretical SAC of each cell configuration is shown in FIG. 7 and FIG. 8. It can be observed that oxidized cell system configuration exhibited higher salt adsorption capacity towards the K⁺ ion. Without wishing to being bound by any theory, the oxidized cell system comprising micropores modified with negative charges, provided enhanced adsorption capacity of ionic species having smaller ionic hydrated sizes, i.e. enhanced adsorption of K⁺ compared to Li⁺, as schematically illustrated in FIG. 1C.

The experimental separation factor β₁/β₂ (also termed selectivity factor) was calculated via Equation VI:

$$\frac{{β}_{1}}{{β}_{2}} = \frac{S A {C}_{1}}{S A {C}_{2}} \frac{{c}_{feed , 2}}{{c}_{feed , 1}} \qquad Equation VI$$

Where:

βᵢ=SACᵢ/C_{feed,I}. (Equation I)

Theoretical selectivity separator was evaluated based on the Donnan model, which assumes a constant potential within the micropores and the macropores bulk in each electrode. Ion size effects were taken into account (Suss, M. E. “Size-based ion selectivity of micropore electric double layers in capacitive deionization electrodes”, Journal of The Electrochemical Society, 164(9), E270-E275, 2017), as well as chemical surface charge (Biesheuvel, P. M., et al. “Theory of water desalination by porous electrodes with immobile chemical charge”. Colloids and Interface Science Communications, 9, 1-5 (2015)). The surface charge values used for fitting for the oxidized cathode were 0.52M and 0.95M. The theoretical selectivity factor was calculated via Equation VII:

$$\frac{{α}_{1 , j}}{{α}_{2 , j}} = \frac{{c}_{ma , 2 , j}}{{c}_{ma , 1 , j}} ( \frac{{c}_{mi , 1} - {c}_{mi , 1}^{0}}{{c}_{mi , 2} - {c}_{mi , 2}^{0}} ) . \qquad Equation VII$$

Where:

C_{ma,i}—is the bulk concentration of each ion (“ma” for macropores);

C_{mi,i}—is the micropore concentration of each ion; and

C_{mi,i0}—is the micropore concentration of each ion, when φ_{elec}=0.

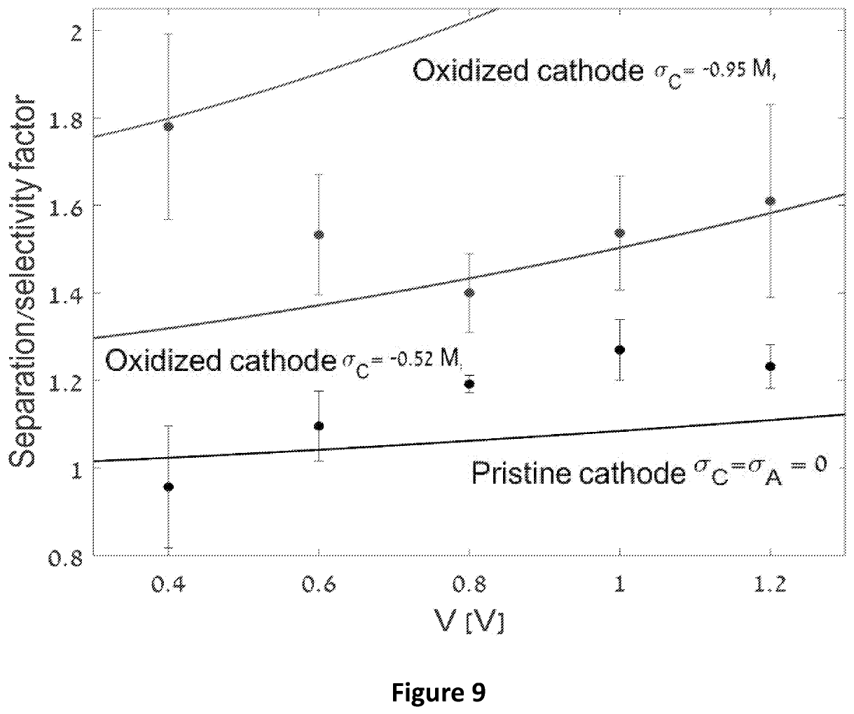

A comparison of the separation factor and the theoretical selectivity factor (FIG. 9) shows a clear boost in selectivity in the electrode system containing the oxidized cathode. Surface charge is used as a fitting parameter in the pristine anode-oxidized cathode system.

For β₁/β₂, the counter ion “1” is defined to be the smaller ion and counter ion “2” is defined as the larger ion, based on the known hydrated ion radius in bulk electrolyte (E. R. Nightingale, “Phenomenological Theory of ion Solvation. Effective Radii of Hydrated ions.” J. Chem. Phys., 63(9), 1381 (1959)).

For the oxidized cathode system experiment, the observed separation factor is significantly above unity (i.e. the values of “1”), ranging between about 1.3 and about 1.6, indicating that the smaller of the two competing ionic hydrated sizes (K⁺) is preferentially electrosorbed by the micropores of the CDI cell.

Without wishing to being bound by theory or mechanism of action, the discrepancy between the theoretical selectivity factor and the experimentally evaluated separation factor can be attributed to the relatively low surface charge of the negatively modified electrode, especially at higher operating potentials. Indeed, when using lower surface charge values for fitting (0.52M instead of 0.95M), there is a better correlation between the experimental and theoretically estimated separation factors.

### Example 7: Modification of Electrode Surface with pH-Independent Charged Surface Groups by Chemical Treatment

The electrodes were composed of squares of an activated carbon cloth (ACC-5092-15, Kynol Europa GmbH). Each cloth had a thickness of about 500 μm, and a surface area of 1500 m²/g (via BET analysis).

For the cathode, the electrode material was subjected to the treatment with sodium dodecyl benzene sulfonate (SBDS) according to the following procedure:

1. 0.15 grams of pristine active carbon were soaked in 10 mM SBDS and 10 mM NaCl solution for about 10 hr in a glass beaker.

2. The electrodes were rinsed with DI water and then soaked for 5 min in fresh deionized water for 2 times.

3. The electrode was then dried in the over for few hours at 80° C.

For the anode, the electrode material is subjected to the treatment with ethylenediamine. The electrode is first oxidized as described in Example 1. Then, the acid-treated electrode is treated with N₂-purged ethylenediamine solution at about 100° C. The heating step is continued until all of the ethylenediamine solution is completely evaporated. The electrode is further cleaned with deionized water, and subsequently dried at about 105° C. under N₂ atmosphere.

### Example 8: Modification of Electrode Surface with Sulfonic Surface Groups

For modification with sulfonic surface groups, electrodes underwent several different modification procedures:

Procedure 1:

An electrode weighting about 4 g was inserted into a flask containing at least 28 mL of 20% sulfuric acid (H₂SO₄). The flask was then closed with a stopper. After 24 hours, the electrode was removed from the flask and soaked with an excess of hexane for 5-10 minutes. The electrode was then transferred to a beaker with deionized water at 0° C. and soaked for 5-10 minutes. The electrode was soaked in deionized water at room temperature three times, each time for 30 minutes. The electrode was dried in air at 80° C. for 12 hours.

Procedure 2:

An electrode weighting about 4 g was soaked in 70% HNO₃ for 3 hours at 80° C. in a reflux system, rinsed in deionized water until the pH was neutral, and dried in air at 80° C. Then the steps in Procedure 1 were executed.

Procedure 3:

An electrode weighting about 4 g was soaked in 70% HNO₃ for 24 hours at room temperature, rinsed in deionized water until the pH was neutral, and dried in air at 80° C. Then the steps in Procedure 1 were executed.

Procedure 4:

An electrode weighting about 4 g was oxidized with 70% HNO₃ (100 mL) at 80° C. for 3 hours in a reflux system. The electrode was washed with DI water. 0.14 g of sodium bicarbonate (NaHCO₃) were dissolved in 12 mL of DI water and 0.42 g of sulfanilic acid (NH₂C₆H₄SO₃H) were added to the solution. The solution can be heated, if needed, to assist dissolution of the powders. The solution was cooled to room temperature and 0.187 g of sodium nitrite (NaNO₂) were added thereto. The solution was cooled in an ice bath till the temperature was below 10° C. 1.75 mL of icy concentrated (32%) hydrochloric acid (HCl) were added to the solution and the reaction continued for 1-2 minutes during which diazonium salt of sulfanilic acid precipitated in the solution as a finely divided white precipitate. Another portion (80 mL) of icy DI water was added to the solution.

### Example 9: Stability of the Sulfonated Electrode in Acidic Medium

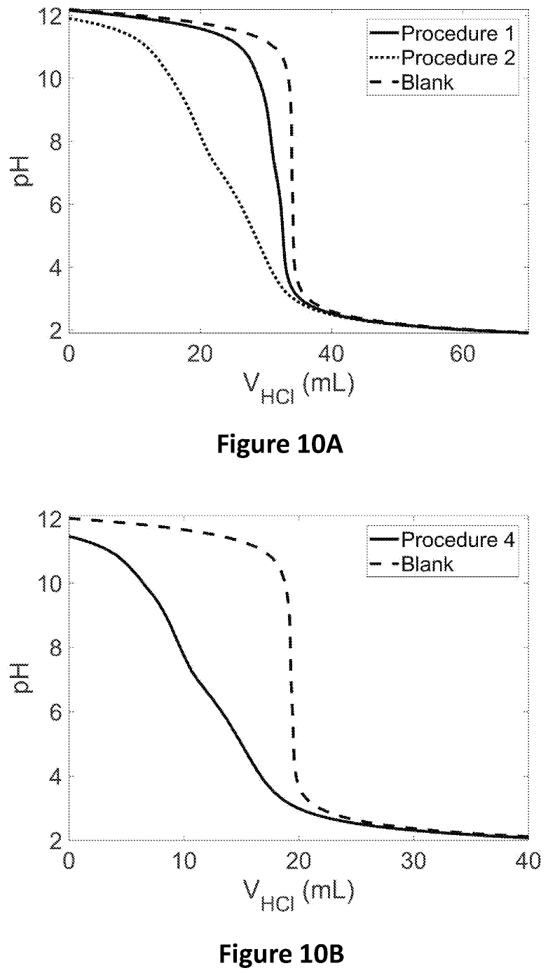

The sulfonated electrode was ground into a powder was placed in a basic solution (˜0.2 g powder, 0.025 M NaOH, 70 mL for Procedures 1 and 2; ˜0.1 g powder, 0.012 M NaOH, 82 mL for Procedure 4) and titrated with HCl (0.05 M) to evaluate sulfonic group stability following acid treatment. Titration results are presented in FIGS. 10A and 10B, and a blank titration without an electrode being present in the solution is shown as a reference in each figure. In FIG. 10A, the titration of the sulfonated electrode from Procedure 1 shows a steep curve and are offset relative to the blank titration, indicating the presence of strong-acid groups that deprotonate upon contact with the initial basic solution but do not protonate in an acidic environment. This curve may be compared with the oxidized electrode titration, shown in FIG. 2B and described in Example 2, which exhibits a gradual slope indicative of weak-acid behavior (i.e. the degree surface group protonation is sensitive to pH). Also in FIG. 10A, the titration of the sulfonated electrode from Procedure 2 shows a more gradual curve, indicating the presence of weak-acid groups as well as strong-acid groups. In FIG. 10B, titration of the sulfonated electrode from Procedure 4 shows a curve similar to that of the electrode of Procedure 2, indicating the presence of weak-acid groups as well as strong-acid groups.

### Example 10: FTIR Analysis of the Sulfonated Electrodes

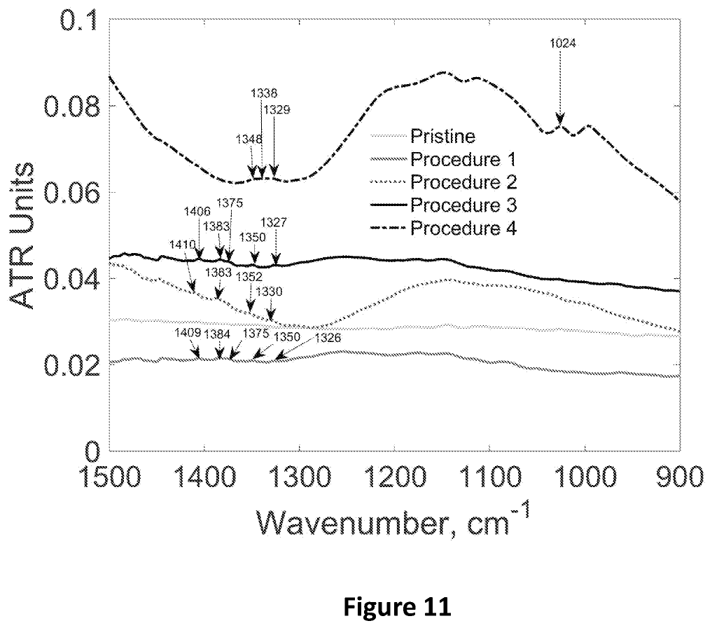

The sulfonated electrodes were further tested by attenuated total reflection Fourier-transform infrared spectroscopy (ATR-FTIR) to assess the presence of sulfur-containing groups on the electrodes. Electrodes were wetted with deionized water and placed into the ATR-FTIR device, and scans between wavenumbers of 399 to 3998 cm′ were performed for each sample. A pristine electrode was used as a background reference for all sulfonated electrodes. FTIR spectra for electrodes modified by Procedures 1-4 described in Example 8, as well as the pristine reference sample are presented in FIG. 11. The peaks labeled in this figure are associated with S═O bond stretching in sulfur-containing compounds, including sulfones, sulfonic acid, sulfonyl chloride, and sulfate, thus providing evidence of sulfur-containing functional groups on the electrodes.

### Example 11: CDI Experimental Procedure with Sulfonated Electrodes

The CDI experimental procedure with sulfonated electrodes is similar to the one described in Example 4. In brief, the feed solution contains 2 mM of analytical-grade KCl, 2 mM of analytical-grade LiCl, and deionized water. The solution is purged with nitrogen gas in a 0.5 L glass reservoir and then pumped by a peristaltic pump into the CDI cell.

The cell is first charged in a single-pass charging configuration, including five cycles of 30 min charging at a constant voltage and 30 min discharging at 0 V. Then, charging is carried out in the same manner and at the same voltage with the exception that charging continued until an equilibrium state is reached (either 2 or 2.5 hours). At equilibrium, the system is switched to a batch charging configuration with 9 mL of continuously-circulating solution initially consisting of feed water, of which 4 mL are contained in a small, continuously-stirred reservoir. The cell is then discharged until the current magnitude is less than 0.1 mA, and the solution conductivity is stable.

The collected batch solutions are analyzed as described in Example 4.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

1. A method for selective separation of ionic species from an ionic solution based on said species ionic hydrated size, the method comprising:
(a) passing the ionic solution comprising at least a first ion and a second ion, said ions being of the same polarity and having distinct hydrated sizes, through an electrode capacitor assembly comprising:
a first electrode and a second electrode, said electrodes comprising carbon having a pore structure comprising micropores, wherein the first electrode is a modified electrode comprising carbon which is modified with negatively charged surface groups and/or the second electrode is a modified electrode comprising carbon which is modified with positively charged surface groups, and
at least one flow channel for the passage of the solution; and
(b) applying an electric potential or charge to the first and the second electrodes,
thereby providing enhanced adsorption of the first ion in the first modified electrode or in the second modified electrode, as compared to the adsorption of the second ion.

2. The method according to claim 1, wherein the hydrated size of the first ion is smaller compared to the hydrated size of the second ion, by at least about 5%.

3. The method according to claim 1, wherein the first ion is a monovalent ion and the second ion is a polyvalent ion.

4. The method according to claim 1, wherein the micropores have a mean pore diameter of below about 2 nm.

5. (canceled)

6. The method according to claim 1, wherein the first modified electrode has a surface charge of at least about 1 M at a pH of 8 or above.

7. The method according to claim 1, wherein the electrode capacitor assembly is characterized by having a separation factor of above about 1.3, for the first ion and the second ion.

8. The method according to claim 1, wherein the first electrode, the second electrode or both comprise carbon selected from the group consisting of activated carbon, carbon black, graphitic carbon, carbon fibers, carbon microfibers, carbon aerogel, fullerenic carbon, carbon nanotubes (CNTs), graphene, carbide, carbon onions, carbon paper, and any combination thereof.

9. The method according to claim 1, wherein the first electrode, the second electrode, or both comprise activated carbon, which is chemically modified.

10. The method according to claim 1, wherein the negatively charged surface groups of the first modified electrode are selected from the group consisting of carboxyl, lactone, quinone, sulfate, sulfonate, phosphate, nitro, halide, hydroxyl, ether, carbonyl, and combinations thereof.

11. The method according to claim 10, wherein the first electrode is a modified electrode and the negatively charged surface groups of the first modified electrode comprise sulfonate.

12. The method according to claim 1, wherein at least about 95% of the surface coverage by the negatively charged surface groups of the first modified electrode and/or by the positively charged surface groups of the second modified electrode is retained following a single cycle of operation of the electrode capacitor.

13. The method according to claim 1, wherein the negatively charged surface groups are attached to the surface of the first modified electrode by covalent bonds and/or the positively charged surface groups are attached to the surface of the second modified electrode by covalent bonds.

14-16. (canceled)

17. The method according to claim 1, wherein the second electrode is a modified electrode, and the positively charged surface groups of the second modified electrode are selected from the group consisting of amine, amide, quaternary amine, ammonium, and combinations thereof.

18. The method according to claim 1, wherein the ionic solution comprises ionic species which are selected from the group consisting of: Li⁺, Na⁺, K⁺, Mg²⁺, Ca²⁺, Cl⁻, Br⁻, F⁻, NO₃⁻, Fe²⁺, Fe³⁺, CrO₄²⁻, Pb²⁺, Hg²⁺, Cd²⁺, In³⁺, Ru³⁺, Ru⁴⁺, Zn²⁺, Co²⁺, Co³⁺, Pt²⁺, Pt⁴⁺, Au⁺, Au³⁺, Ag⁺, Sn⁴⁺, Sn²⁺, Sn⁴⁻, Cu²⁺, and combinations thereof, and wherein the ionic solution further comprises water or an organic solvent.

19. (canceled)

20. The method according to claim 1, wherein the at least one flow channel is formed by at least one of a separator, membrane, gasket, spacer, and salt bridge, and wherein the ionic solution flows in the flow channel directly through the electrodes, wherein the flow within the flow channel is configured orthogonally to the electrode surface plane.

21. The method according to claim 1, wherein the electrode capacitor assembly further comprises a first current collector and a second current collector, and wherein the first electrode is positioned between the first current collector and the flow channel, and the second electrode is positioned between the flow channel and the second current collector, and wherein the first electrode, second electrode, or both comprise a flowable carbon electrode in the form of a suspension and/or a fluidized bed electrode.

22-25. (canceled)

26. The method according to claim 1, wherein the electrode capacitor assembly is a part of a wastewater treatment system, a brackish water desalination system, or a chemical reactor.

27. The method according to claim 26, wherein the flow channel comprises at least two ion-permeable membranes, and the water desalination system is configured in a form of a Capacitive Deionization (CDI) system or a Membrane Capacitive Deionization System (MCDI), further comprising a feed tank, a feed pump, and a waste tank.

28-30. (canceled)

31. A method for selective separation of ionic species from an ionic solution based on said species ionic hydrated size, the method comprising:
(a) passing the ionic solution comprising at least a first positively charged ion and a second positively charged ion having distinct hydrated sizes, wherein the hydrated size of the first ion is smaller compared to the hydrated size of the second ion, by at least about 5%, through an electrode capacitor assembly comprising:
a first electrode and a second electrode, said electrodes comprising carbon having a pore structure comprising micropores, wherein the first electrode comprising carbon is modified with fixed sulfonate surface groups, and
at least one flow channel for the passage of the solution; and
(b) applying an electric potential or charge to the first and the second electrodes,
thereby providing enhanced adsorption of the first positively charged ion in the first electrode as compared to the adsorption of the second positively charged ion.

32. (canceled)

33. The method according to claim 31, wherein the first positively charged ion is a monovalent ion and the second positively charged ion is a polyvalent ion.

34-48. (canceled)
